(19) United States
(12) Patent Application Publication
(10) Pub. No.: US 2024/0341525 A1
(43) Pub. Date: Oct. 17, 2024

(54) DUAL FLOW HOLDING CONTAINER

(71) Applicant: CARTER-HOFFMANN LLC, Mundelein, IL (US)

(72) Inventors: Sreekanth PUSHPALA, Mundelein, IL (US); Juan GUTIERREZ, Mundelein, IL (US)

(21) Appl. No.: 18/633,057

(22) Filed: Apr. 11, 2024

Related U.S. Application Data
(60) Provisional application No. 63/458,816, filed on Apr. 12, 2023.

(51) Int. Cl. A47J 36/24

(52) U.S. Cl. CPC A47J 36/2483

(57) ABSTRACT

An open food storage container is provided. The container includes a housing with side walls and end portions that establish a holding volume. The side walls and end portions are arranged with the right side wall extending from the first and second end portions and the left side wall also extending from the first and second end portions. The first and second end portion include air handling units and heating elements, the air handling units are configured to draw air in a first direction through a suction substantially parallel to a plane parallel to the side walls and discharge air in a second direction substantially perpendicular to the plane. The second end portion is configured to draw air in a third direction through a suction, wherein the third direction is opposite from the first direction and substantially parallel to the plane, and discharge air in the second direction.

### BACKGROUND OF THE INVENTION

This application claims priority from U.S. Provisional Application No. 63/458,816, filed on Apr. 12, 2023, the entirety of which is hereby fully incorporated by reference herein.

### BACKGROUND OF THE INVENTION

This disclosure relates to equipment used in a commercial or restaurant kitchen to cook and store prepared food prior to presentation to the customer.

### SUMMARY OF THE INVENTION

A first representative embodiment of the disclosure is provided. The embodiment includes an open food storage container. The container includes a housing comprising a bottom, right and left side walls and first and second end portions that in combination establish a holding volume, wherein the side walls and end portions are arranged with the right side wall extending from the first and second end portions and the left side wall also extending from the first and second end portions, wherein the right and left side walls are substantially parallel with each other. The first end portion includes a first air handling unit and a first heating element, wherein the first air handling unit is configured to draw air in a first direction through a suction substantially parallel to a plane parallel to the right and left side walls and discharge air in a second direction substantially perpendicular to the plane. The second end portion includes a second air handling unit and a second heating element, wherein the second air handling unit is configured to draw air in a third direction through a suction, wherein the third direction is opposite from the first direction and substantially parallel to the plane, and discharge air in the second direction. The first air handling unit and the second air handling unit each include fans, wherein the fan in the first air handling unit rotates in a clockwise direction when viewed straight on from the holding volume, and the fan in the second air handling unit rotates in a counter-clockwise direction when viewed straight on from the holding volume. A first tray is received upon the housing and within the holding volume and the first tray is removable from the housing without the need for use of any tools, and a second tray that is received upon the first tray and within the holding volume, wherein the second tray is removable from the first tray without the need for use of any tools. The first tray comprises right and left side walls, first and second end walls, and a bottom wall, wherein the right and left side walls, the first and second end walls, and the bottom wall collectively establish an open cavity, wherein when the first tray is disposed within the housing the left wall of the first tray is proximate to the left side wall of the housing, the right wall of the first tray is proximate to the right side wall of the housing, the first end wall is proximate to the first end portion of the housing, and the second end wall is proximate to the second end portion of the housing.

Another representative embodiment of the disclosure is provided. The embodiment includes an open food storage container. A housing comprising a bottom, right and left side walls, and first and second end portions that in combination establish a holding volume, wherein the side walls and end portions are arranged with the right side wall extending from the first and second end portions and the left side wall also extending from the first and second end portions. The first end portion includes a first air handling unit and a first heating element, wherein the first air handling unit is configured to draw air in a first direction through a suction substantially parallel to a plane parallel to one or both of the right and left side walls and discharge air in a second direction substantially perpendicular to the plane. The second end portion includes a second air handling unit and a second heating element, wherein the second air handling unit is configured to draw air in a third direction through a suction, wherein the third direction is opposite from the first direction and substantially parallel to the plane, and discharge air in the second direction.

Other representative embodiments include the embodiment of the two paragraphs above as combined with the features of one or more of Representative Paragraphs 1-38 provided at the end of this specification.

Yet another representative embodiment includes an open food storage container. The container includes a housing comprising a food storage compartment and an air handling compartment, the housing formed from front, back, right, and left side walls, and a bottom wall, the air handling compartment includes a fan and a heater that is disposed proximate to a discharge of the fan such that air that flows through the discharge of the fan flows across the heater. The food storage compartment is disposed proximate to the air handling compartment with a center wall that separates the food storage compartment from the air handling compartment, the center wall is parallel to the front wall of the housing. The center wall includes a plurality of first holes disposed proximate to a top edge of the center wall, and a plurality of second holes disposed proximate to a bottom region of the food storage compartment. A food storage tray that is removably received within the food storage compartment, wherein the food storage tray includes a bottom surface and right and left side walls that each extend upwardly from opposite ends of the bottom surface, the food storage tray include a plurality of spaced holes within the bottom surface. The food storage compartment comprises a width and a length, wherein the width is six inches.

Yet still another representative embodiment includes an open food storage container. The container includes a housing comprising a food storage compartment and an air handling compartment, the housing formed from front, back, right, and left side walls, and a bottom wall, the air handling compartment includes a fan and a heater that is disposed proximate to a discharge of the fan such that air that flows through the discharge of the fan flows across the heater. The food storage compartment is disposed proximate to the air handling compartment with a center wall that separates the food storage compartment from the air handling compartment, the center wall is parallel to the front wall of the housing. The center wall includes a plurality of first holes disposed proximate to a top edge of the center wall, and a plurality of second holes disposed proximate to a bottom region of the food storage compartment. The container also includes a food storage tray that is removably received within the food storage compartment, wherein the food storage tray includes a bottom surface and right and left side walls that each extend upwardly from opposite ends of the bottom surface, the food storage tray include a plurality of spaced holes within the bottom surface. The plurality of second holes are arranged in a plurality of vertical columns that are proximate to each other, wherein the plurality of vertical columns are arranged such that from a center of center wall toward both right and left edges of the center wall the plurality of vertical columns are grouped into a first plurality with one second hole, then a second plurality with two stacked holes, then a third plurality with three stacked holes.

Other representative embodiments include the two paragraphs directly above as further limited by one or more of the features described in the Representative Paragraphs 39 to 66 provided at the end of this specification.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of an open storage container 10.

FIG. 2 is an exploded perspective view of the container of FIG. 1 from a different perspective.

FIG. 3 another exploded perspective view of the container of FIG. 1 from another different perspective.

FIG. 4 is a perspective view of the housing of the container of FIG. 1.

FIG. 5 is a different perspective view of the housing of FIG. 4.

FIG. 6 is a perspective view of the first tray of the container of FIG. 1.

FIG. 7 is a different perspective view of the first tray of FIG. 6.

FIG. 8 is a cross-sectional view of the container of FIG. 1 depicting the first and second gaps and the air flow establishing the air curtain.

FIG. 9 is another cross-sectional view of the container of FIG. 1 depicting the air flow through the first and second pluralities of apertures.

FIG. 10 is a cross-sectional side view of the first tray of FIG. 6.

FIG. 11 is another cross-sectional view of the container of FIG. 1 depicting the air flow through the walls of the second tray.

FIG. 12 is a side cross-sectional view of the container of FIG. 1.

FIG. 13 is a top perspective view of another open food storage container.

FIG. 14 is a top rear perspective view of the container of FIG. 13.

FIG. 15 is the container of FIG. 13 with the food storage tray (second tray) exploded therefrom.

FIG. 16 is the container of FIG. 13 depicting the first tray and the food storage tray exploded from each other.

FIG. 17 is a perspective cross-sectional view of section R-R of FIG. 13.

FIG. 18 is a front cross-sectional view of section R-R of FIG. 13.

FIG. 18a is a detail view of detail CC of FIG. 18.

FIG. 19 is a perspective cross-sectional view of section R-R of FIG. 13 with the first tray removed.

FIG. 20 is a front cross-sectional view of section R-R of FIG. 13 with the first tray removed.

FIG. 21 is a top perspective view of the housing of the container of FIG. 13 with the first and second trays removed.

### DETAILED DESCRIPTION OF THE INVENTION

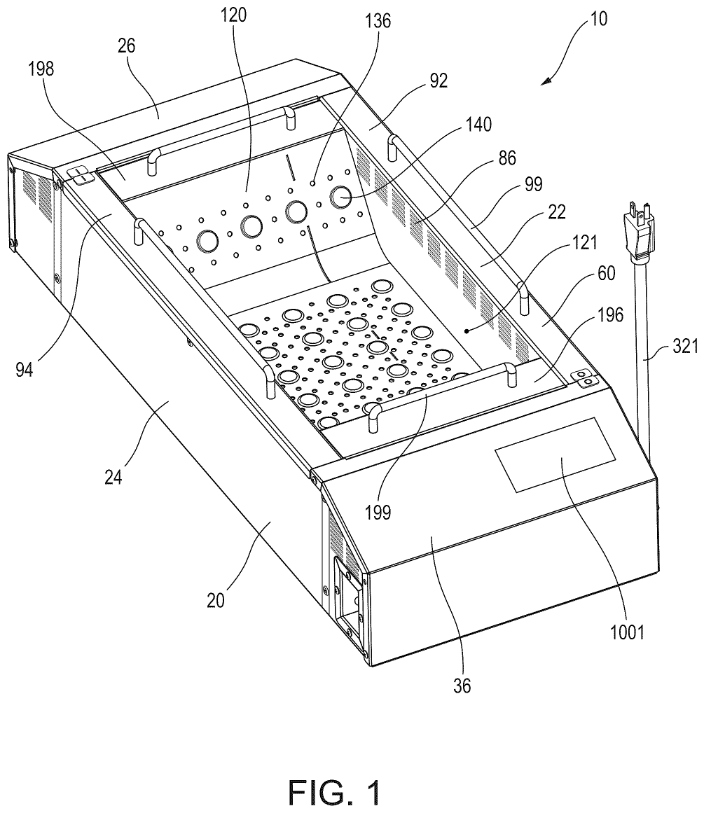

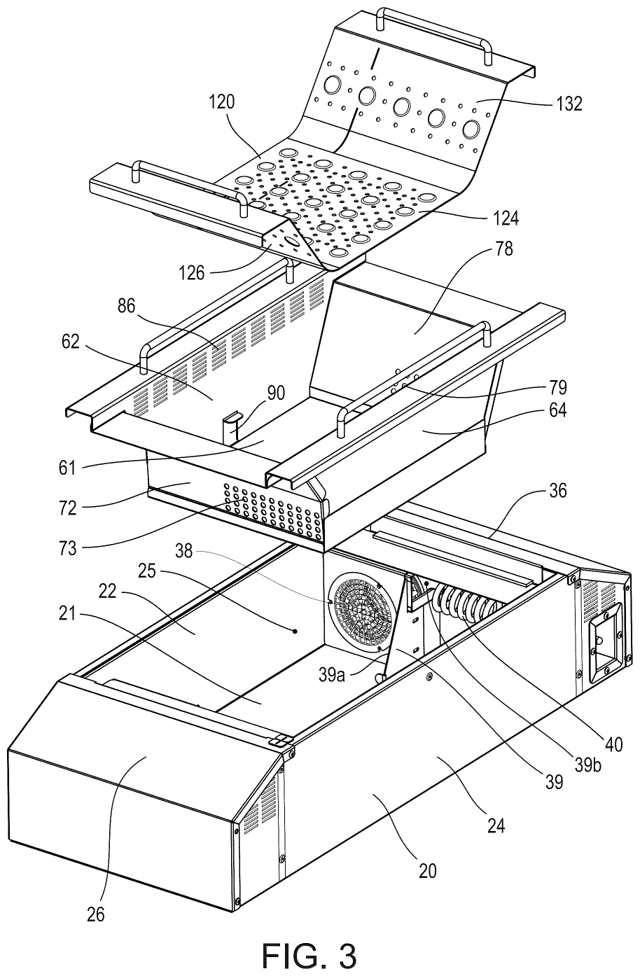

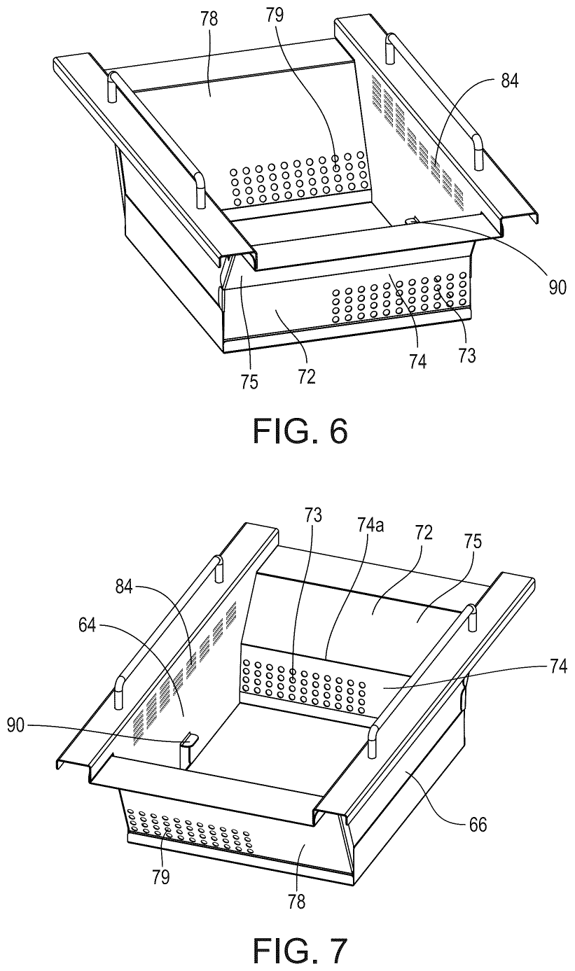

Turning now to FIGS. 1-12, an open food storage container 10 is provided. The container 10 may be provided to hold and store food cooked food, but is awaiting distribution to a customer. Similarly, the container 10 may receive partially cooked food that is intended to be held for a period of time (in a warmed, or cooled condition) until further cooking steps. For example, the container may include pre-cooked food that that will be packaged or portioned for serving to a customer, or it may include pre-cooked food that is awaiting self-service by a customer, such as when the container 10 is included within a buffet line or similar. The container 10 may be configured to rest upon a counter top, or may be configured to be a drop-in style within an aperture in a counter top. The container may be permanently mounted to a counter or other structure within a facility, or it may be portable.

The container 10 is specifically described herein as a warming container to maintain cooked food disposed there food in a warm condition before serving or packaging. In other embodiments, the container may be configured to maintain food disposed therein a cool condition, such as with a cooling system (refrigerated or with active cooling, such as Peltier technology, or the like). In other embodiments, the container may include both warming and cooling systems that can be selectively operated as desired, and the container 10 can be operated with forced ambient temperature air.

The container 10 includes three components, a housing 20, a first tray 60, and a second tray 120. The first tray 60 is configured to rest within a holding volume 23 of the housing 20, and the second tray 120 is configured to rest within an open cavity 61 of the first tray 60. The first tray 60 rests within the housing due to gravity and can be placed within and removed from the holding volume 23 of the housing without any tools, simply by manipulating the first tray by one or more handles 99 upon the first tray 60 when provided.

The second tray 120 rests within the first tray 60 due to the force of gravity and can be placed within and removed from the open cavity 61 without any tools, simply by manipulating the second tray 120 by one or more handles 199 upon the second tray 120 when provided.

The first tray 60 and the second tray 120 are configured to be removable to allow access to the holding volume 23 within the housing 20 for maintenance and for cleaning of the housing 20/holding volume 23, and the first tray 60 and the second tray 120 are configured to be readily removed for cleaning, such as being able to be washed within a typical dish washer of a typical restaurant or food service facility or washed manually.

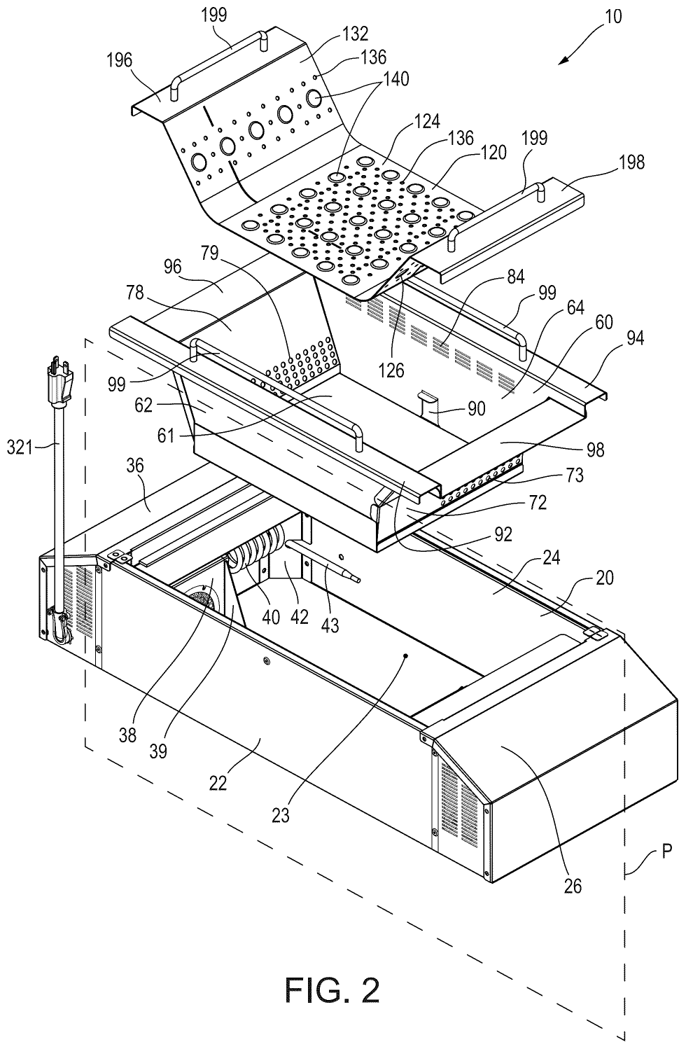

The housing 20 is best shown in FIGS. 2-5 and 11-12. The housing 20 includes first and second end portions 36, 26, a right side wall 22, a left side wall 24, and a bottom wall 21. The term “wall” as used herein for the right side wall, left side wall and the bottom wall are used to incorporate a single wall, or wall assemblies that include two or more components to establish an outer surface of the housing and an inner surface that directly establishes a portion of the holding volume 23.

The first and second end portions 36, 26 are portions that perform several functions that are discussed herein, such as establishing front and rear sides of the housing, wherein the first side (i.e. the side of the first end portion 36) is typically the side that faces the user of the container 10 in typical operations. In some embodiments, the container 10 may be positioned within a facility where it can be accessed by users from both the first and second sides, such as accessible for use from both sides of a counter. One of ordinary skill in the art with a thorough review and understanding of this specification and figures will readily understand that the terms “front” and “rear” as used here, such as from the perspective of a user, are not in any way limiting to the structure of the container 10 and that the container 10 can be positioned in any direction with respect to any potential users. The terms first and second are used herein to refer to specific portions of the container 10 for the ease of understanding and consistency.

The first and second end portions 36, 26 further each are provided to house the temperature control and air handling systems associated with the container 10. Each of the first and second end portions 36, 26 include an air handling unit and a temperature control element, through which air from the air handling unit blows to modify the temperature of the air flowing therethrough. Air then leaves the temperature control element and returns into the holding volume, where it flows into the open cavity of the first tray 60 and the food holding volume 121 of the second tray 120 such that the air interacts with food product that is disposed within the food holding volume 121 and establishes an “air curtain” across the top of the food holding volume 121.

The first and second end portions 36, 26 may further enclose of components of the device such a controller 1000 (schematic) that works on conjunction with one or more temperature sensors 43 (such as a RTD, a thermocouple, or the like), a display (when provided) 1001, a power cord 321 (either a hard wired power cord or a typical power cord for a portable device as well known in the art, or via power cords with quick connect terminals as known in the art) among other features.

The first and second end portions 36, 26 are arranged such that the air handling unit 38, 28 of the respective first and second end portions 36, 26 are each proximate to the right side wall 22 of the housing. The air handling units 38, 28 preferably have the same air moving capacity such that the same flow of air pulled from the holding volume 23 via the suction of each air handling unit and the same volume of air is pushed through each adjacent temperature control element and to return to the holding volume 23.

In some embodiments, the air handling units 38, 28 may be fans, or air pumps or similar devices known to pull air in and push air out at a higher pressure. Fans 38, 28 are depicted in the figures, but other types of air handling units may be provided as will be readily understood by one of ordinary skill in the art with a thorough review of this specification.

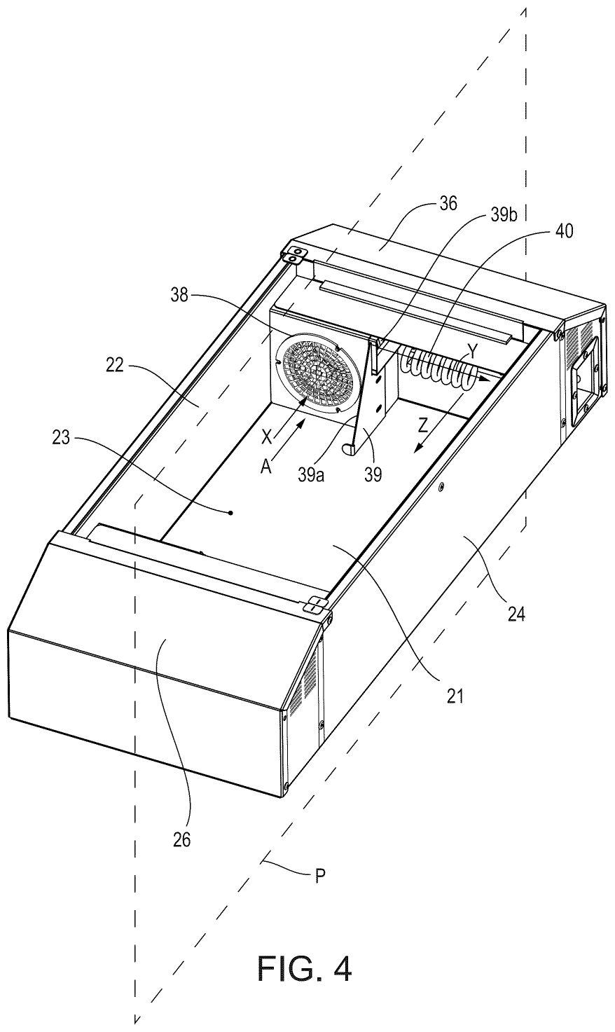

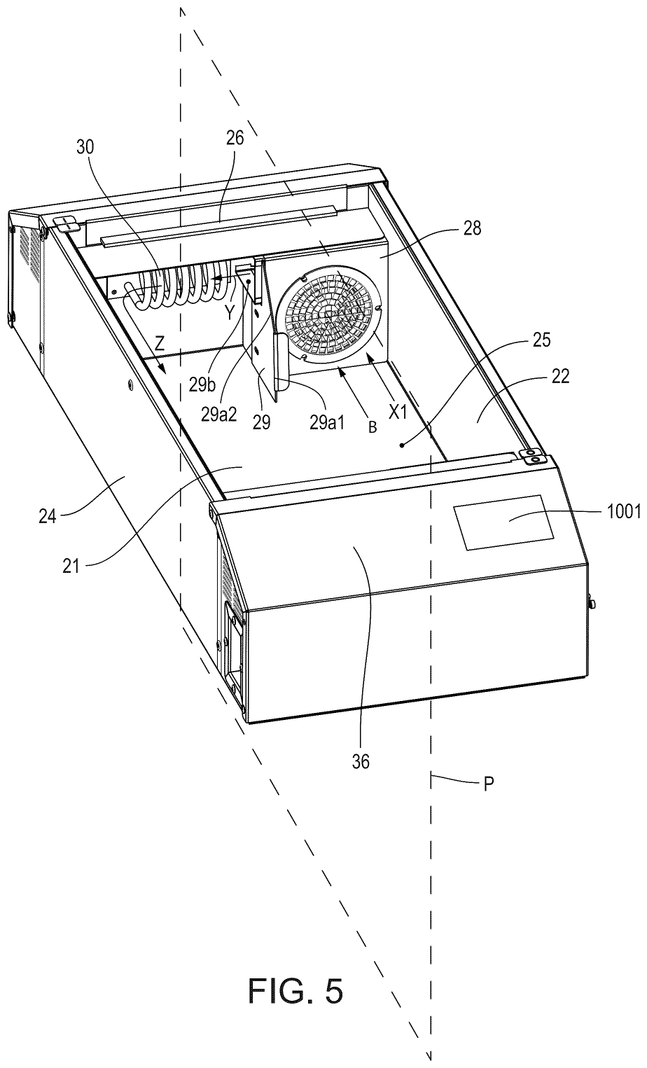

The air handling units 38, 28 are arranged within their respective first or second end portion 36, 26 both proximate to the right wall 22, and the first and second air handling units 38, 28 are arranged to push air therefrom in opposite directions to each other—from the perspective of viewing front (suction) of the respective air handling unit from within the holding volume (the viewing directions A, and B depicted in FIGS. 4 and 5). For example, in embodiments where the first and second air handling units 38, 28 are rotating fans, the two fans rotate in the opposite directions, the fan 38 rotates in the clockwise direction (when the air handling unit 38 is viewed straight on from within the holding volume 23 in the direction A) to expel air in a direction perpendicular Y to the intake direction X, i.e. expel air in a direction toward the left wall 24 of the housing and away from the right wall 22 of the housing 20. The fan 28 rotates in the counter-clockwise (when the air handling unit 28 is viewed straight on from within the holding volume 23 in the direction B) direction to expel air, in the same direction Y as the fan 38 expels air, to expel air as the first fan 38. The first and second air handling units 38, 28 draw suction in opposite directions X, X1 (FIGS. 4, 5), that are each parallel to a plane P that is parallel to the one or both of the right and left side walls 22, 24 of the housing.

In some embodiments, the first and second air handling units 38, 28 operate at a constant speed, and constantly when power is provided to the container 10, while in other embodiments, the air handling units 38, 28 may be operated at differing speeds or on duty cycles to achieve a desired air flow and temperature control within the holding volume, which may be controlled with feedback control by the controller 1000.

The temperature control elements may be heaters, such as resistance heaters 40, 30, or they may be other heat generation elements. Alternatively, the temperature control elements may be devices that cool air flowing therepast, such as Peltier elements, or heat exchanger coils with cooled exchange fluid, such as associated with a refrigeration system. For the sake of brevity, resistance heaters 40, 30 are discussed in detail herein, but one of ordinary skill in the art with a thorough review of the subject specification would readily understand how to adapt the container 10 to include cooling capability, or either cooling or heating capability with merely routine optimization.

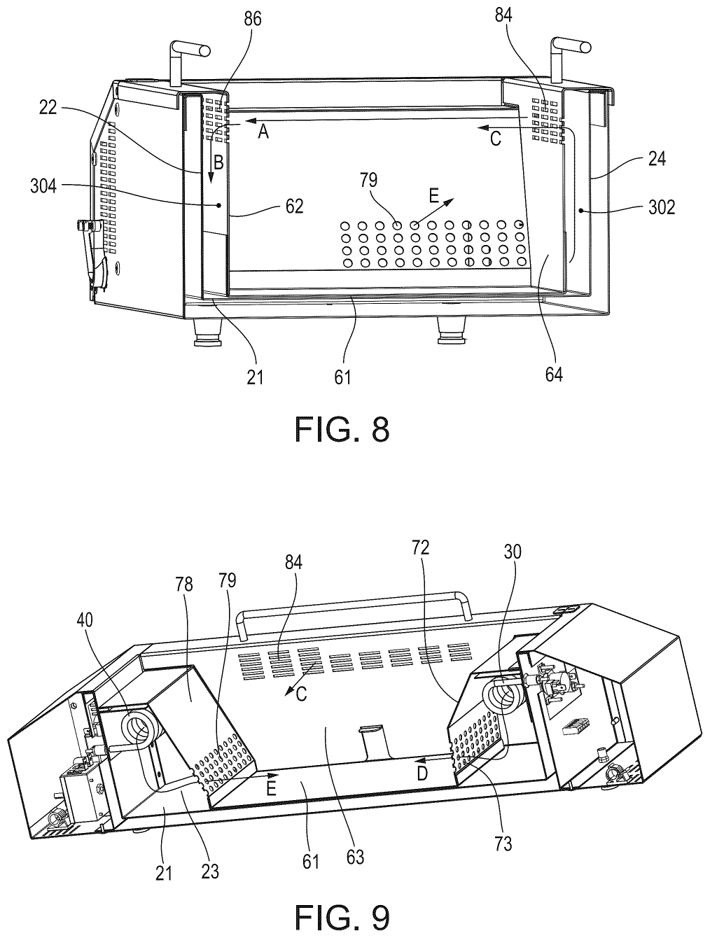

The heaters 40, 30 are positioned within the discharge air flow path from the adjacent air handling unit 38, 28, such that the air discharging from the air handling unit in the direction Y flows past the respective heater 40, 30. As discussed above, the heaters 40, 30 may be constantly on at a certain power level, or in other embodiments, the duty cycle and/or the power level of the heaters 40, 30 may be varied by the controller 1000 using feedback control, and/or via a preprogrammed recipe, or manually by a user via user input controls associated with the display 1001. During operation of the heaters 40, 30, the air flowing past in the direction Y increases in temperature due to convection air flow of the air, the air then flows toward one of the flow paths discussed above and ultimately into the open cavity 61 of the first tray 60 and some of the air flows through other apertures and into the receiving volume 121 of the second tray 120 so that the heated air interacts with the food product disposed within the receiving volume 121, and such that the air that flows out of the third apertures 84 of the left wall 64 of the first tray 60 and toward the fourth apertures 86 in the right wall 62 of the first tray 60 to establish an air curtain (A, FIG. 8) above the second tray 120.

In some embodiments, the housing 20 may include one or more baffles 42 (FIG. 2) to urge the air leaving the adjacent heating element to curve to a direction where the air flows into the first gap 302 as well as through the adjacent apertures (79, 73) in the adjacent first or second wall 78, 72. In some embodiments, a baffle 42 may be only provided in the first end portion 36, while in other embodiments a baffle 42 may be only provided in the rear end portion 26. Baffles 42 may be provided in both end portions.

The first and second end portions 36, 26 each may include respective bulkheads 39, 29 that separate the adjacent air handling unit 38, 28 and the neighboring heaters 40, 30. The bulkheads each have an aperture 39b, 29b that allows a path for air flow from the discharge of the air handling unit 38, 28 to the neighboring heater 40, 30 in the direction Y. The bulkheads also extend into the holding volume with an exposed edge 39a, 29a with a vector component that faces vertically and a vector component that faces inwardly (i.e. opposite direction than direction X) at least for a portion of the exposed edge 39a, 29a. The bulkheads 39, 29 each provide mechanical support to the first tray 60 when it is disposed in position within the holding volume 23. As discussed below, in some embodiments, the first tray 60 has first and second ends 78, 72 that are formed with different geometries and the exposed edge 39a, 29a of the respective first and second bulkhead 39, 29 is formed with the same geometry (or very similar geometry) as the first and second ends 78, 72 such that the first tray 60 an only rest properly within the holding volume 23 in one orientation.

The first tray 60 includes a right wall 62, a left wall 64 and first and second walls 78, 72. When installed within the housing the first tray 60 is positioned such that the left wall 64 is adjacent the left wall 24 of the housing to establish a first gap 302 therebetween, and the right wall 62 of the tray 60 is adjacent to the right wall 22 of the housing 20 to establish a second gap 304 therebetween. In some embodiments, the top of the tray includes right and left flanges 92, 94, and first and second flanges 96, 98. These flanges 92, 94, 96, 98 rest upon upper edges of the respective right and left walls 22, 24 and first and second end portions 36, 26 of the housing when the first tray 60 is positioned within the holding volume 23 of the housing. The respective right and left flanges 92, 94 enclose the top of the first and second gaps 302, 304.

In some embodiments, first and second walls 78, 72 have different geometries. For example, in a representative embodiment the first wall 78 is a completely planar, while the second wall 72 includes two or more sections. For example, the second wall 72 includes a first section 74 that intersects with the bottom wall 61 and a second section 75 that intersects with the first section 74 at an edge 74a. The first section 74 and the second sections 75 are at different angles with respect to the bottom wall. For example, in one embodiment, the first section 74 may be at an angle α with respect to the bottom wall 61, with the angle α being perpendicular or about perpendicular, or just slightly obtuse (e.g. 95, 100, 105, 110 degrees) with the second section 75 being at an angle β that is larger than angle α such as 120, 125, 130, 135, 140 and the like. In the embodiments where the first and second walls 78, 72 are formed with different geometries from each other the respective bulkheads 39, 29 are formed with the same geometries as the respective first and second wall 78, 72 such that the first tray 60 rests within the housing 20 and upon the bulkheads 39, 29 in only one orientation (with the first tray 60 fitting such the flanges of the first tray 60 rest upon the corresponding horizontal top surfaces of the housing 20.

The engagement between the first tray 60 and the bulkheads 39, 29 establish a boundary of the second gap 302 that extends from the area where the heaters 40, 30 are positioned. Air that flows through the apertures 39b, 29b in the bulkheads 39, 29 and past the heaters 40, 30 in direction Y, then flows either through the pluralities of apertures 79, 73 (discussed below) or into the first gap 302 between the left wall 26 of the housing and the left wall 62 of the first tray 60. The left wall 64 has a plurality of apertures 84 are positioned near a top edge of the left wall 64 and allow heated air to flow therethrough (arrow C, FIG. 8) and into the open cavity 63 to establish the air curtain (A) above the open cavity (and above the second tray 120 when installed) as discussed elsewhere herein.

A second gap 304 is established between the right wall 62 of the first tray 60 and the right wall 22 of the housing 20. The second gap 304 allows for fluid communication with the suction of each of the first and second air handling units 36, 26. During operation of the air handling units 36, 26, a vacuum is drawn within the second gap 304, which pulls air through a plurality of apertures 86 in the right wall 62 of the pan 60. The air pulled through the apertures 86 (B, FIG. 8) draws air from the open cavity of the first tray and the receiving volume 126 of the second tray 120, as well as from the air curtain that is established by air flowing from the first gap 302 and the plurality of apertures 84.

The air that is drawn into the second gap 304 through the second apertures 86 splits such that some of the air is directed to the suction of the first fan 38 (direction X) and the remainder is drawn to the suction of the second fan 28 (direction X1).

The first wall 78 and the second wall 72 each include a plurality of adjacent apertures 79, 73 that are proximate to the position of the heater 40, 30 proximate to the respective first and second wall 78, 72. The plurality of adjacent apertures 79, 73 allow heated air through the respective first and second walls 78, 72 in directions E (through the apertures 79 in the first wall) and D (through the apertures 73 in the second wall 72). The apertures allow the heated air to flow into a third gap 306 below the second tray 120 when installed within the first tray 60. The third gap 306 is established due to the sizes and geometries of the first and second walls 78, 72 of the first tray and the sizes and geometries of the first and second walls 132, 126 of the second tray. In some embodiments, the first tray 60 includes a ledge 90 that the bottom wall 124 of the second tray 120 rests upon to further establish the third gap 306.

The first and second pluralities of adjacent apertures 79, 73 are each disposed on the side of the respective first or second bulkhead 39, 29 below the respective first and second wall 78, 72 when the first tray 60 is installed within the housing 20. In some embodiments, the first and second bulkheads extend along the same plane.

In some embodiments, all of the apertures from each of the pluralities of adjacent apertures 79, 73 are disposed with their center (either center of a circular aperture or geometric center for a non-circular aperture) at a distance closer to the left wall 64 of the first tray 60 than a distance from the center to the right wall 62. In other embodiments an overwhelming majority of the pluralities of adjacent apertures 79, 73 are disposed with their center at a distance closer to the left wall 64 than the right wall 62. The overwhelming majority is defined herein to be a percentage that is significantly above 50% such as for example, 75% and above and inclusive of all values above 75%.

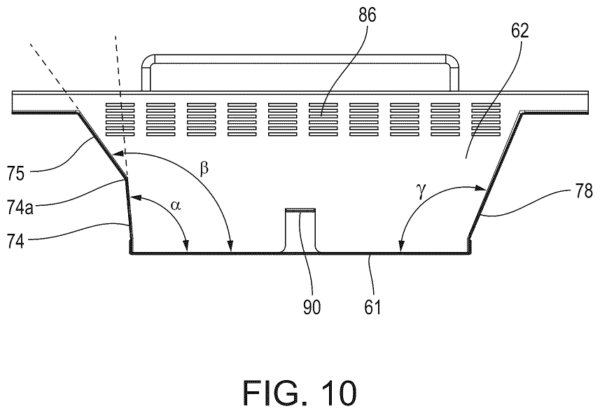

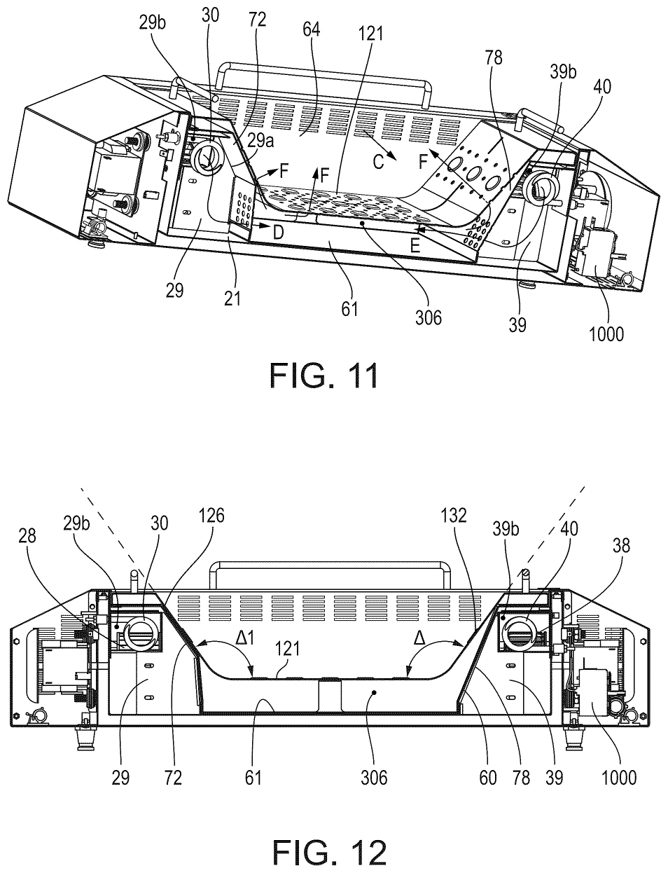

The second tray 120 is best shown in FIGS. 2, 3, and 11. The second tray 120 includes opposite flanges 196, 198 that rest upon end flanges 96, 98 of the first tray 60. The second tray 120 includes first and second side walls 132, 126 and a bottom wall 124. The first and second side walls 132, 126 are disposed at obtuse angles (Δ, Δ1) with respect to the neighboring first and second walls 78, 72. The angles Δ, Δ1 may be the same or they may be different. The angles Δ, Δ1 are preferably slightly less than the angles γ (FIG. 10, 12, between first wall 78 and the bottom 61) and the angle β (FIG. 10, 12, between second portion 75 of the second wall 72 and the bottom 61) to allow air to flow within the third gap 306 along the first and second walls 78, 72 of the first tray and out the apertures 136 in the second tray 120 (flow F, FIG. 11).

A plurality of apertures 136 are disposed throughout the side walls 132, 126 and the bottom wall 124 to allow air from the third gap 306 to flow therethrough and into the food receiving volume of the second tray 120 to heat the food product stored therein. As discussed above the third gap 306 is between the bottom wall 124 of the second tray 120 and the bottom wall 61 of the first tray 60, as well as between the respective side walls (78 and 132, and 72 and 126) to allow the heated air to enter into the storage volume in a direction with a horizontal vector component (i.e. in a direction with a vector component parallel to the bottom wall 124 of the second tray 120).

In some embodiments the surface of the second tray (bottom wall 124 and side surfaces 132, 126) may include a plurality of spaced stand-offs 140. The stand offs 140 allow for food product to rest at a position away from the remaining surface of the wall to allow for some air flow below the bottom portions of the food product disposed within the second tray 120. The stand-offs 140 and the apertures 136 are arranged in a geometric, and in some embodiments repeating, pattern to allow for uniform flow through all of the apertures 136. In some embodiments, the apertures 136 may be at different distances from adjacent apertures 136 depending upon the position of the respective aperture upon the second tray 120 and specifically due to the distance from the respective aperture from the apertures 79, 73 in the first tray. In some embodiments, the size (diameter for circular apertures) of the apertures 136 may also vary based upon distance. One of ordinary skill in the art will readily understand that varying the position of various adjacent apertures based upon distance away from the apertures 79 or 73 and/or the size of various apertures based upon distance away can be used to balance the mass flow rate of heated air through all of the apertures. This can be readily understood by one of ordinary skill in the art with a thorough review and understanding of this specification and the design of positioning the apertures and sizing the apertures can lead optimizing toward a uniform mass flow rate through all of the apertures 136 with merely routine optimization.

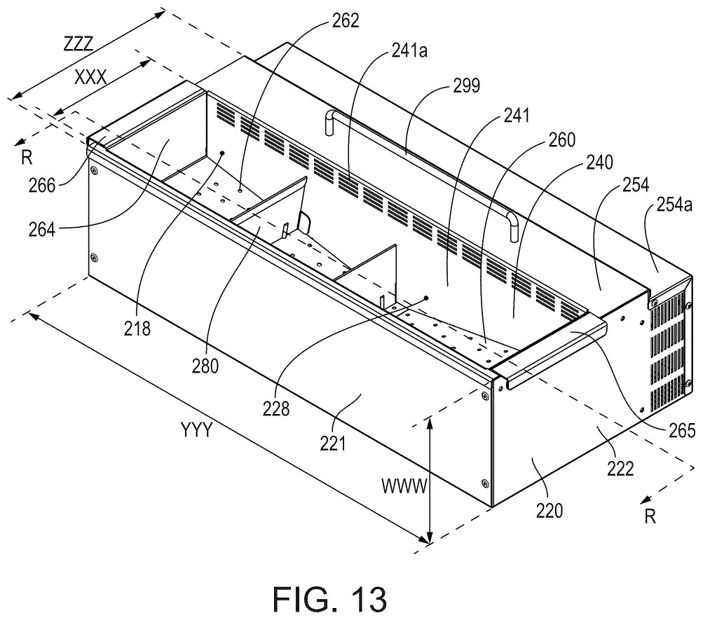

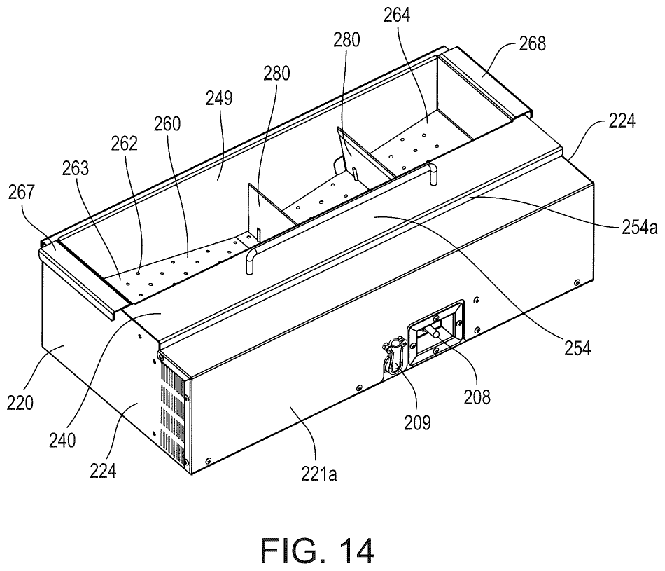

Turning now to FIGS. 13-21, another open food storage container 200 is provided. The container 200 may be provided to hold and store food cooked food, but is awaiting distribution to a customer. Similarly, the container 200 may receive partially cooked food that is intended to be held for a period of time (in a warmed, or cooled condition) until further cooking steps. For example, the container may include pre-cooked food that that will be packaged or portioned for serving to a customer, or it may include pre-cooked food that is awaiting self-service by a customer, such as when the container 200 is included within a buffet line or similar. The container 200 may be configured to rest upon a counter top, or may be configured to be a drop-in style within an aperture in a counter top. The container may be permanently mounted to a counter or other structure within a facility, or it may be portable.

The container 200 is specifically described herein as a warming container to maintain cooked food disposed there food in a warm condition before serving or packaging. In other embodiments, the container 200 may be configured to maintain food disposed therein a cool condition, such as with a cooling system (refrigerated or with active cooling, such as Peltier technology, or the like). In other embodiments, the container may include both warming and cooling systems that can be selectively operated as desired, and the container 200 can be operated with forced ambient temperature air.

The container 200 includes three components, a housing 220, a first tray 240, and a second tray 260. The first tray 240 is configured to rest within a holding volume 228 of the housing 220, and the second tray 260 is configured to rest within an open cavity 256 of the first tray 240. The first tray 240 rests within the housing 220 due to gravity and can be placed within and removed from the holding volume 228 of the housing without any tools, such as by lifting the first tray 240 by one or more handles 259 from the first tray 240, when provided. The second tray 260 is provided to receive food thereon that is desired to be held for later serving or later preparation. The second tray 260 receives a continuous flow of heated air through a plurality of apertures 262 in the surface of the tray, with the heated air passing by and interacting with food disposed upon the second tray 260.

The first tray 240 and the second tray 260 are configured to be removable to allow access to the holding volume 228 within the housing 220 for maintenance and for cleaning of the housing 220/holding volume 228, and the first tray 240 and the second tray 260 are configured to be readily removed for cleaning, such as being able to be washed within a typical dish washer of a typical restaurant or food service facility or washed manually.

The second tray 260 may support one or more dividers 280 (FIG. 13) that are removable from the second tray 260 and can be positioned in different locations as desired for creating different segregated spaces for food upon the second tray 260.

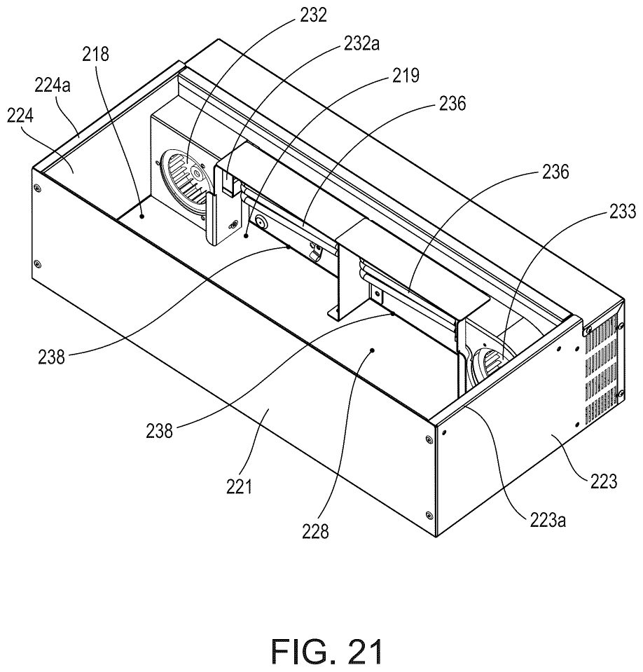

The housing 220 is best shown in FIG. 21. The housing 220 includes a food storage compartment 219 and an air handling compartment 218. The housing is formed by a front wall 221, a right wall 223, a left wall 224, and a bottom wall 229. A rear wall 221a is provided. In some embodiments, the rear wall 221a may include an on/off switch 208 in embodiments where the container is controlled either on or off, as discussed herein, the temperature of the air flow (any one of WW or VV as desired) may be controlled by a controller (700, schematic) using conventional temperature feedback control techniques. In other embodiments, the user may provide inputs for operation (temperature, fan speed, input the contents of food within the container, so that a controller—700 (schematic) may hold the food based upon a recipe), and the unit in those embodiments may have a user input/display feature that may be upon other surfaces of the housing 220. The user input/display may also communicate with an external computer, phone and the like to receive instructions or to be networked with other parts of the kitchen for automated operation. The rear wall may also include the electrical cable for providing power to the container 200 (209 is the connection for the cable (not shown). In some embodiments, the container may be controllable by the operator, such as the operator having the ability to select air flow level (either actual air flow or “slow” “fast” etc.) as well as the air temperature setting, which would be maintained as desired by the controller 700.

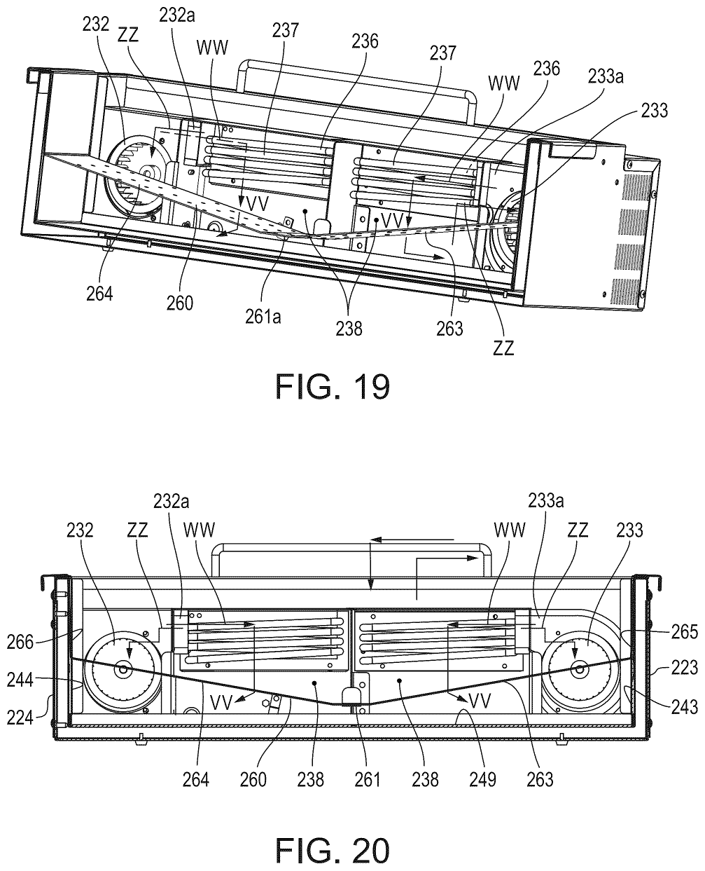

The air handling compartment 218 includes at least one fan 232 and heater 236 assembly, and preferably includes two fans 232, 233 and heater 236 assemblies, as depicted in FIG. 20. In other embodiments, where the length of the housing 220 is increased, the air handling compartment 218 could include three or more fan and heater assemblies. In some embodiments, the fans 232 and 233 are arranged with an opposite rotational direction, for example the fan 232, which is on the left side of the housing 220 as depicted on the page on FIG. 21 would rotate clockwise (from the perspective of viewing fan 232 from within the food storage compartment 218) such that the air that flows out of the fan discharge 232a flows (flow WW, FIG. 19, schematic) toward the center of the housing and past the neighboring heaters 236, and the second fan 233 which is on the right side of the housing 220 would rotate counter-clockwise such that air that flows out of the fan discharge 233a flows (flow WW, FIG. 19, schematic) toward the center of the housing and past the neighboring heaters 236.

The heaters 236 are arranged proximate to the discharge of each fan 232, 233 such that air from the fan flows across the heaters (WW) to receive heat from the heaters via convection heat transfer. The air handling compartment 218 may have a wall 237 (FIG. 19) that extends outboard of the heaters that prevents air WW flowing from the discharge 232a, 233a of the fan from flowing directly into the food storage compartment. Instead, the wall 237 allows for the discharge air WW to flow across the heaters 236 and then flow downwardly within the air handling compartment to proximate a bottom surface 229 and into a space 238 below the heaters 236 (flow VV, FIGS. 19-20). The air flow VV then flows through the central wall 241 of the first tray 240 as discussed below.

The food storage compartment 218 of the housing 220 is formed from the front wall 221, the right and left walls 223, 224 and the floor 229. Within the housing 220 the food storage compartment 218 leads directly to the air handling compartment 219 (other than the positions where the walls 237 are provided. The air handling compartment 219 and the food storage compartment 218 are separated by the center wall 241 of the first tray 240.

The first tray 240 is provided and in some embodiments when installed rests upon the top edges/surfaces of one or more of the right and left walls 223, 224 of the housing, as well as a ceiling 219a of the air handling compartment 219. The first tray 240 rests in place with gravity and in some embodiments does not have any components to actively maintain the first tray 240 in place. In other embodiments, a latch may be provided to allow for mechanically retaining the first tray 240 in place upon the housing 220, which can be released by the user when it is desired to remove the first tray 240, such as for cleaning or maintenance. In some embodiments, a position sensor (not shown) may be provided that identifies when the first tray 240 is properly positioned upon the housing, with the fans 232, 233 and/or the heaters 236 only being operable when the sensor identifies that the first tray 240 is properly positioned upon the housing 220. In some embodiments, the sensor may be a button that is moved to a depressed position when the first tray 240 is positioned thereon (thereby sending a signal or closing a contact in the electrical power flow wiring for the fans and/or the heaters to allow electrical current to flow to the fans and/r the heaters) and is biased to a second position when the first tray 240 is removed or not properly positioned, which stops sending the signal, sends a different signal, or opens the contact, thereby preventing current to flow to the fans and/or the heaters. The first tray 240 may include a side portion 254 that rests upon the portion of the housing 220 that covers the top of the air handling compartment 219. In some embodiments, the housing 220 that encloses the air handling compartment may have a top surface that is at two or more different heights, and the side portion 254 of the first tray 240 may have a flange 254a that extends along a vertical wall in the housing between the different height portions, with the engagement between 254a and the housing 220 assisting with properly positioning the first tray 240 upon the housing 220.

The first tray 240 may be sized to leave a space RR between the floor 249 of the first tray 240 and the floor 228 of the housing 220 when the first tray is properly positioned. The space may be provided to allow for collection of liquid or crumbs therein to avoid fouling the floor 249 of the holding environment 248 within the first tray 240 when properly installed. The first tray and the second tray 240, 260 may both be removed when desired for cleaning of the housing 220. In a preferred embodiment, the right wall 243 of the first tray 240 is aligned parallel to and either in contact or positioned with very little space between the right wall 223 of the housing, and the left wall 244 of the first tray is aligned parallel to and either in contact or positioned with very little space between the left walls 224 of the housing and the left wall 244 of the first tray—to maximize the volume of the holding environment 248 for a given outer geometry of the housing 220. Similarly, the front wall 242 of the first tray 240 is parallel to and either in contact or positioned with very little space between the front wall 221 of the housing 220 to maximize the volume of the holding environment 248 for a given outer geometry of the housing 220.

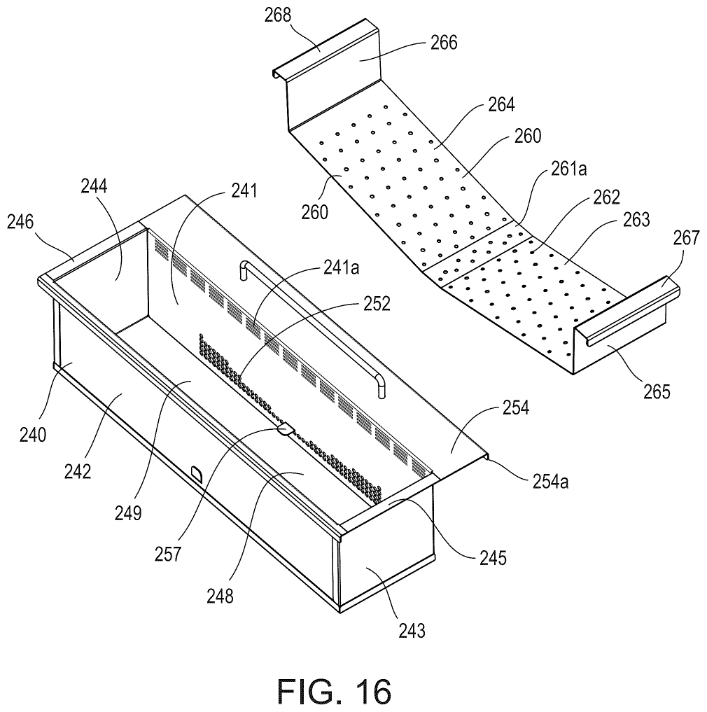

The first tray is best understood with reference to FIGS. 16-18. The first tray 240 includes a central wall 241 that establishes a barrier between the food storage compartment 218 (within holding environment 248) and the air handling compartment 219.

The center wall 241 may be parallel to the first wall 221 of the housing 220. The center wall 241 includes a first plurality of holes (or louvers) 241a and a second plurality of holes 252 disposed therein. The first plurality of holes 241a may be disposed proximate to a top edge 241z of the center wall 241 and the plurality of holes 252 are disposed proximate to or within a bottom portion 241y of the center wall 241. The first and second pluralities of holes are discussed below.

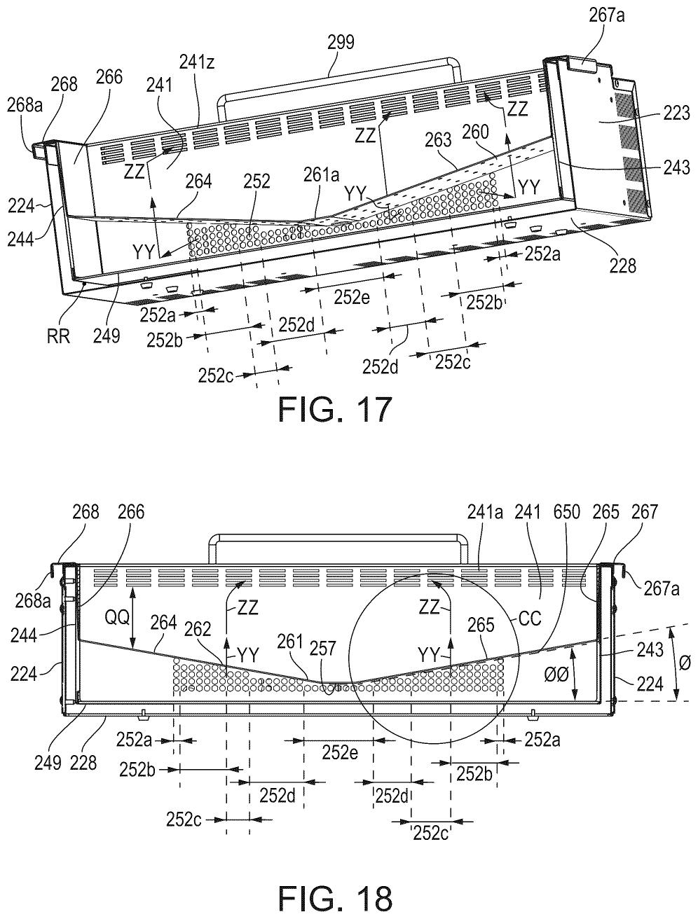

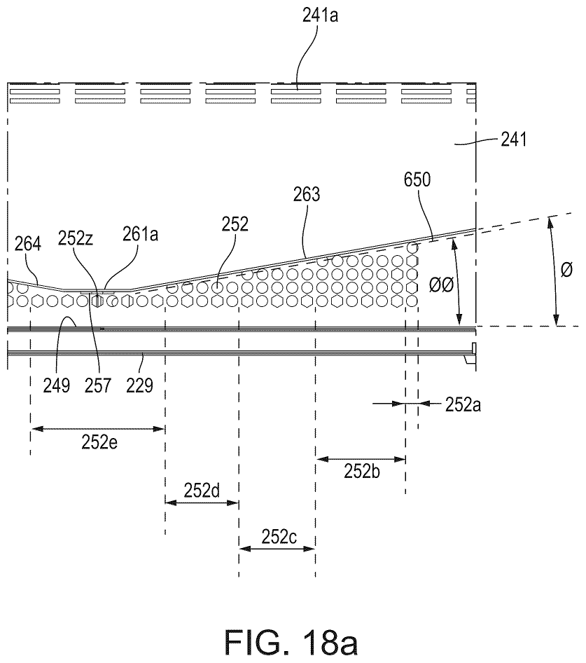

The first plurality of holes 241a are provided to allow air flow (flow ZZ, FIGS. 17, 18, schematic) from the food storage compartment 218—and specifically from a position above the second tray 260, as discussed below)—and into the air handling compartment 219. The first plurality of holes may be aligned in organized rows and columns (as depicted in FIGS. 17 and 18) along the top of the center wall 241, and in preferred embodiments with the holes 241, with the various rows extending from proximate to the right wall 243 of the first tray 240 to proximate to the left wall 244 of the first tray. The holes 241a are arranged a substantial distance (QQ) above the second tray 260 such that air that flows through the second tray 260 (as discussed below) flows upwardly (through the food product that is disposed upon the second tray 260—as described below) and into the first holes 241, which establishes air flow along the entire length of the food storage compartment 218. In the embodiments depicted herein, each hole 241 is approximately rectangular (although the corners of a geometrical may be rounded) with the long side of each hole 241a extending parallel to the floor 249 to the second tray 240. The holes 241a into several columns of holes that neighbor adjacent columns of holes. In other embodiments, the plurality of holes may be arranged in a different manner than columns and rows, with the holes sized and arranged in a manner to allow a significant air flow through the holes 241a, while minimizing the amount of food pieces or particles that can fit through the holes 241a.

With compared reference to FIGS. 17-20, the holes 241a are arranged to allow air that flows therethrough (air flow ZZ) to flow into the air handling compartment, based upon suction within the air handling compartment 219 provided by the fans 232, 233. The air that flows through the holes 241a on the right half of the center wall tends to flow to the right fan 233 and the air the flows through the holes on the left half of the center wall tends to flow to the left fan 232. As discussed above, a wall 237 may be provided within the air handling compartment that is inboard of the holes 241a, and particular the holes that are aligned proximate to the heaters 237, which prevents air flowing through the holes (ZZ) from flowing directly to the heaters 237. Instead, the wall 237 is spaced from the center wall 241 to create a plenum, through which air can flow as it flows to the suction of the fan 232, 233 that is most proximate to the respective hole 241a (between wall 237 and center wall 241).

The second set of holes 252 are best understood with reference to FIGS. 17, and 18. The second set of holes 252 are aligned to receive air from the space 238 below the heaters, with heated air within space 238 flowing through the holes 252 and into the food storage compartment, as depicted schematically as air flow VV. The holes 252 are all positioned such that they are below the second tray 260 when the second tray 260 is properly installed upon the first tray 240 as discussed below.

In the embodiment depicted in the figures, the second set of holes 252 are aligned in a plurality of columns that are arranged across a central portion of the center wall 241, proximate to the floor 249 of the first tray 240. The arrangement of the columns of holes 252 is discussed in further detail below.

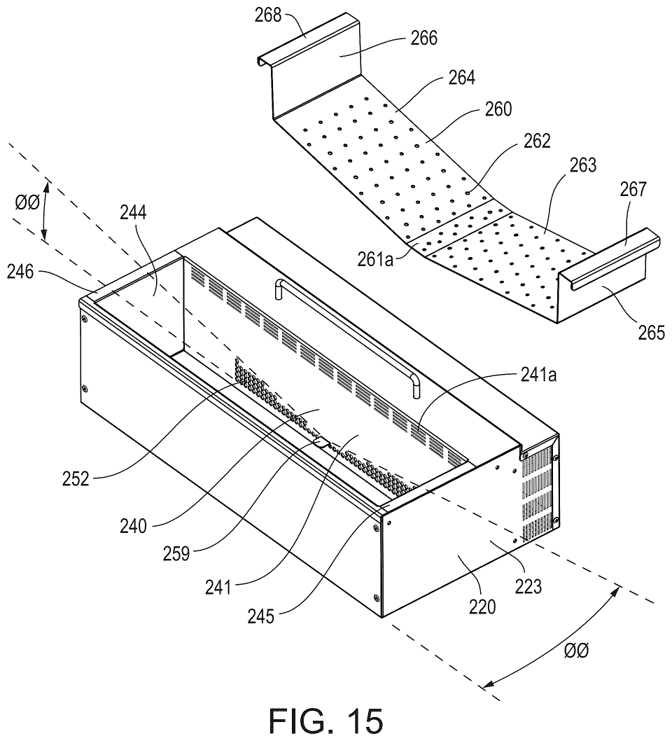

The second tray 260 is best shown in FIGS. 15-18. The second tray 260 preferably includes a bottom wall 261 that extends to a right wall 265 and a left wall 266. The bottom wall 261 includes first and second angled portions 263, 264 that each extend from a center (or a center portion 261a) at an acute angle Φ with respect to the floor 249 of the first tray 240 when the second tray 260 properly rests upon the first tray 240. In a preferred embodiment the first and second angled portions 263, 264 extend from the center (or center portion 261a) in opposite directions and at the same acute angle Φ. The angle Φ may be within a range of about 5 degrees to about 20 degrees, preferably within a range of about 8 degrees to about 15 degrees, and more preferably about 10 degrees. The first and second angled portions 263, 264 may be planar along their entire length, or may include two or more planar portions. The two or more planar portions may form the entirety of the each angled portion, or a portion of each angled portion may be curved.

In some embodiments, the length of the first and second angled portions 263, 264 may be the same, so that both sides of the second tray 260 are the same, and therefore the second tray 260 can be properly installed upon the first tray in either orientation. The second tray 260 includes first and second end walls 265, 266 that when the second tray 260 is properly installed upon the first tray, the first end wall 265 is parallel to and contacts or is in very close proximity to the one of the right or left wall 243, 244 of the first tray, and the opposite second end wall 266 is parallel to and contacts or is in very close proximity to the other of the right or left wall 243, 244. The first and second walls 265, 266 may each support a ledge 267, 268 that extends outwardly in a cantilevered manner from a top edge of the respective wall, with the ledges 267, 268 resting upon the top of the respective right and left walls 245, 246 when the second tray 260 is installed upon the first tray 240. The second tray 260 may rest upon the first tray 240 and be maintained in position completely with the force of gravity. In some embodiments, a latch (not shown) may be provided that may maintain the second tray 260 properly positioned upon the first tray 240. Each ledge 267, 268 may include a downward surface 267a, 268a that extends from an end edge of each ledge. The ledges 267, 268 may extend outboard of the housing 220 (FIG. 18) to allow the user to easily hold onto the ledges 267, 268 (and the downward surfaces 267a, 268a when provided) to remove the second tray 260 from the first tray 240, and to position the second tray 260 upon the first tray 240.

The second tray 260 may include a center portion 261a that is between the first and second angled portions 263, 264 and is disposed at a geometric center of the second tray 260. In some embodiments, the second tray 260 may rest upon one or more ledges 257 that extend from the center 241 and front 257 of the first tray 240 to support the center portion 261a upon the first tray. The center portion 261a may be planar and parallel to a floor 249 of the first tray 240 when the second tray 260 is installed therein, while in other embodiments, the center portion 261a may be “v” shaped with the opposite legs of the “V” extending to the respective first and second walls 265, 266—either at the same angle Φ or at a different angle. The ledge 257 may be the same shape and orientation as the center portion 261a for surface to surface contact therebetween.

The second tray 260 includes a plurality of holes 262 that are disposed through the first and second angled portions 263, 264 (and the center portion 261a when it has a width greater than the diameter of two holes). The holes 262 allow for air flow from below the second tray 260 therethrough to a space above the second tray 260, as depicted schematically as air flow YY (FIGS. 17, 18). The holes 262 may be uniformly arranged within the second tray to establish a uniform flow of air throughout the second tray 262. In a first embodiment, the holes 262 are in the same pattern throughout the first and second angled portions 263, 264 with the same spacing throughout. In other embodiments, the holes may have a greater spacing between adjacent holes proximate to the center of the second tray 260 than a spacing of adjacent holes proximate to the walls 265, 266 of the second tray 260. This second alternative may be beneficial to provide a balanced of air flow YY along the entire length of the second tray—due to the fact that the plurality of the second holes 252 through the center wall 241 are disposed proximate to the center of the center wall 241 and specifically aligned for flow directly from the spaces 238 below the heaters 237, and not aligned in registry with the two fans 232, 233 (to avoid air flowing through the holes 252 from flowing directly into the fans 252 and not through the second tray and through the upper holes 241a.

The second tray 260 may be formed from a single piece (such as stainless steel) and bent into the desired shape of the second tray 260.

As discussed above, the plurality of second holes 252 within the center wall 241 are arranged in a pattern and are disposed proximate to the spaces 238 below the heaters 237, such that air that flows past the heaters and into the spaces 238 blows directly through the holes 252 and into the food storage compartment 218.

In a preferred embodiment as depicted in FIGS. 18, and 18, the holes 252 are arranged in a plurality of columns, with the totality of the columns arranged such that the position of the vertically uppermost hole 252 within each column being positioned just below the bottom surface of the second tray 260, specifically the bottom surface of the first or second portion, or central portion 263, 264, 261a that is positioned vertically above the column.

In one embodiment and as best shown in FIGS. 18 and 18a, the holes 252 within the geometric center of the center wall 241 each form a first group (252e) with a height of a single hole, columns outboard of the first group form a second group (252d) on one or both sides of the first group each have a height of two holes (with a small space between the two holes—such as the minimum space needed for strength of the center wall at that region given the anticipated forces and stressed upon the center wall—which can be readily determined by one of ordinary skill in the art with a thorough review of this specification with merely routine optimization), columns outboard of the second group form a third group (252c) that each have a height of three holes (with the minimum spacing as discussed above). In some embodiments, there may be columns outboard of one or both of the third groups that form a fourth group (252b) that each have a height of four holes (with the minimum spacing discussed above). In some embodiments, there may be one or more columns outboard of the columns of the fourth group that each have a height of five holes (with the minimum spacing discussed above). In the embodiment depicted in the figures, the fifth group has a single column, but more columns may be provided. Further groups outboard with additional holes in a column may be provided in additional embodiments. As discussed above, it is preferred that the second holes 252 extend only as wide as the combined width of the spaces 238 under the two sets of heaters 237—and not to a position proximate to the fans 232, 233 to avoid short circuit air flow from the space 238 directly to the fans and not flowing through the second tray 260.

The various groups of columns of holes 252 may be positioned, such that a line 650 (FIG. 18a) that extends through the center hole of the first group 252d (hole 252z, FIG. 18a) that also extends from the upper most hole of the inboard most column within each group of columns (i.e. the most inboard column within group 252d, the most inboard column within group 252c, etc.). In some the embodiment depicted in FIGS. 18 and 18a the line 650 is parallel (or substantially parallel) with the plane that the first or second portion 263, 264 of the second tray that is above the respective columns. In this embodiment, the line 650 makes an acute angle ΦΦ with the floor 249 of the first tray 240. In some embodiments, the angle ΦΦ is the same or substantially the same as angle Φ. The term “substantially the same” is defined herein to be the nominal angle and including a range of angles that is plus or minus 5 degrees from the reference angle. The term “substantially parallel” is defined herein to include parallel lines along with lines that have portions that are up to 5 degrees away from parallel with the reference line.

The holes 252 may all be circular holes, while in other embodiments, the holes 252 may all be square or rectangular (including generally square or rectangular shapes with curves at intersecting surfaces instead of corners for manufacturability), or ovals, or other shapes for air flow. In some embodiments, the holes 252 may include several different sizes and/or shapes within the plurality of holes, or within different columns, or within the same column. The holes 252 are preferably formed to minimize the possibility of food particles extending through the holes to avoid fouling the air handling compartment during operation and between cleaning cycles.

As discussed above, air flows through the plurality of holes 252 and into the food storage compartment (flow VV). Air then flows through the holes 262 in the second tray 260 to a region above the tray, where the air flows across the food that rests upon the second tray. The air (flow ZZ) then flows from the area above the second tray (and past the food) and through the first holes 241a to return to the air handling compartment (flow ZZ).

In a preferred embodiment, the width of the food storage compartment (dimension XXX—FIG. 13) is 6 inches or just over 6 inches. The term just over is defined herein to include the nominal value recited and a range of 5 percent above the nominal value. The width is the usable width within the food storage compartment 218 (i.e. between the center wall 241 and the front wall 242 of the first tray 240. In this embodiment, the width of the overall housing (dimension ZZZ, both the food storage compartment and the air handling compartment (measured from the outer surface of the housing 220 forming each)) is 12 inches or just over 12 inches. In a preferred embodiment, the length (dimension YYY) of the food storage compartment is 24 inches or just over 24 inches. The height (dimension WWW) of the housing is 7 inches or about 7 inches (not including the height of any handles or other ergonomic features—e.g. 299 that extend from any of the components). The applicant is not aware of any commercialized products that include a narrow food storage compartment of 6 inches or just over six inches with the dimensions specified above. The ability to construct an open food storage container with the above dimensions, and the critical 6 inches (or just over 6 inches) width is due to the inclusion of the inventive features disclosed herein. In other embodiments the length (YYY) of the food storage compartment may be other dimensions, such as 20 inches, 28 inches, 32 inches, 26 inches, and the like, or other standard lengths with a similar total length that are appropriate in countries that use the metric system). One of ordinary skill in the art will understand that for longer versions (which will have a larger food storage compartment) a third set of fans and heaters may be needed. In that case—the plurality of holes 252 may be repositioned within the center wall, such as in a different arrangement of columns of holes) to maximize the inclusion of the holes that are below the level of the second tray 260, and positioned to not be proximate to any fan suctions to avoid short circuiting air flow to avoid the food storage compartment 218 as discussed above.

The term “about” is specifically defined herein to include a range that includes the reference value and plus or minus 5% of the reference value. The term “substantially the same” is satisfied when the width of the end surfaces of the holes are both within the above range. The term “substantially parallel” is satisfied when the two items being compared are exactly parallel or disposed with an angle between the two of less than 5 or 10 degrees. The items being compared may be substantially parallel and have planar shapes, as well as when the items are generally planar (i.e. they extend along a plane but have one or more portions that do not extend within the plane), such as items with portions of relatively minor curvature or interior angles where a plane can be readily fit along the item between its end portions and through a significant percentage of the item. The term “overwhelming majority” is defined herein to mean 80% or more (and including all) of the items within the group being described.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification and be readily understood with reference to the following representative paragraphs:

Representative Paragraph 1: An open food storage container, comprising:
a housing comprising a bottom, right and left side walls, and first and second end portions that in combination establish a holding volume, wherein the side walls and end portions are arranged with the right side wall extending from the first and second end portions and the left side wall also extending from the first and second end portions;
the first end portion includes a first air handling unit and a first heating element, wherein the first air handling unit is configured to draw air in a first direction through a suction substantially parallel to a plane parallel to one or both of the right and left side walls and discharge air in a second direction substantially perpendicular to the plane,
the second end portion includes a second air handling unit and a second heating element, wherein the second air handling unit is configured to draw air in a third direction through a suction, wherein the third direction is opposite from the first direction and substantially parallel to the plane, and discharge air in the second direction.

Representative Paragraph 2: The open food storage container of Representative Paragraph 1, wherein the first air handling unit and the second air handling unit each include fans, wherein the fan in the first air handling unit rotates in a clockwise direction when viewed straight on from the holding volume, and the fan in the second air handling unit rotates in a counter-clockwise direction when viewed straight on from the holding volume.

Representative Paragraph 3: The open food storage container of either of Representative Paragraphs 1 or 2, further comprising a first tray that is received upon the housing and within the holding volume and the first tray is removable from the housing without the need for use of any tools, and a second tray that is received upon the first tray and within the holding volume, wherein the second tray is removable from the first tray without the need for use of any tools,
wherein the first tray comprises right and left side walls, first and second end walls, and a bottom wall, wherein the right and left side walls, the first and second end walls, and the bottom wall collectively establish an open cavity, wherein when the first tray is disposed within the housing the left wall of the first tray is proximate to the left side wall of the housing, the right wall of the first tray is proximate to the right side wall of the housing, the first end wall is proximate to the first end portion of the housing, and the second end wall is proximate to the second end portion of the housing.

Representative Paragraph 4: The open food storage container of Representative Paragraph 3, wherein the first tray comprises a first plurality of adjacent apertures that are disposed on the first end wall proximate to the first heating element at the first end portion when the first tray is disposed within the holding volume, a second plurality of adjacent apertures that are disposed on the second end wall proximate to the second heating element at the second end portion when the first tray is disposed within the holding volume.

Representative Paragraph 5: The open food storage container of Representative Paragraph 4, wherein the first tray further comprises a third plurality of adjacent apertures that are disposed on the left wall, and a fourth plurality of adjacent apertures that are disposed on the right wall,
wherein a first gap is established between the left side wall of the housing and the left wall of the first tray, wherein a portion of the air that discharges from the first and second air handling units and flows past the adjacent respective first and second heating elements then flows into the first gap;
and wherein a second gap is established between the right side wall of the housing and the right wall of the first tray, wherein air flowing through the fourth plurality of adjacent apertures flows into the second gap, a first portion of the air flowing through the fourth plurality of apertures flows to the suction of the first air handling unit and a remaining portion of the air flowing through the fourth plurality of apertures flows to the suction of the second air handling unit.

Representative Paragraph 6: The open food storage container of Representative Paragraph 5, wherein air flows from the third plurality of adjacent apertures to the fourth plurality of adjacent apertures to establish an air curtain across the open cavity at an opening into the first tray.

Representative Paragraph 7: The open food storage container of Representative Paragraphs 5 or 6, wherein the second tray rests upon the first tray and establishes a third gap between adjacent walls of the second tray and the first tray.

Representative Paragraph 8: The open food storage container of Representative Paragraph 7, wherein air flowing through the first and second pluralities of adjacent apertures flows into the third gap, wherein the second tray comprises a fifth plurality of apertures disposed throughout the second tray, wherein air flowing into the third gap flows through the plurality of fifth apertures and into a receiving volume that is established by walls of the second tray.

Representative Paragraph 9: The open food storage container of Representative Paragraph 8, wherein when the second tray is disposed upon the first tray the receiving volume is nested within the open cavity of the first tray, and when the first tray is received within the housing the open cavity is disposed within the holding volume.

Representative Paragraph 10: The open food storage container of any of Representative Paragraphs 3-9, wherein first end wall of the first tray is planar, and the second end wall includes a first planar portion and second planar portion, wherein the first planar portion and the second planar portion intersect at a horizontal edge, wherein the first planar portion is disposed at a smaller angle with respect to the bottom wall than the second planar portion is disposed with respect to the bottom wall.

Representative Paragraph 11: The open food storage container of Representative Paragraph 10, wherein the first planar portion of the second end wall is about perpendicular to the bottom wall and the second planar portion of the first or second end wall is at an obtuse angle to the bottom wall.

Representative Paragraph 12: The open food storage container of Representative Paragraph 10, wherein the first end portion of the housing further comprises a first bulkhead disposed between the first air handling unit and the first heating element, wherein the first bulkhead includes an exposed edge that points into the holding volume, wherein the exposed edge establishes a straight line along its length,
wherein the second end portion of the housing further comprises a second bulkhead disposed between the second air handling unit and the second heating element, wherein the second bulkhead includes an exposed edge that points into the holding volume, wherein the exposed edge includes a first straight portion and a second straight portion that intersect each other, wherein the first straight portion is disposed at a smaller angle with respect to the bottom wall than the second straight portion is disposed with respect to the bottom wall.

Representative Paragraph 13: The open food storage container of Representative Paragraph 12, wherein the first and second bulkheads are configured such that the first tray can only positioned within the housing such that the first end of the first tray is adjacent the first end portion of the housing and the second end of the first tray is adjacent the second end portion of the housing.

Representative Paragraph 14: The open food storage container of any one of Representative Paragraphs 3-13, wherein the first plurality of adjacent apertures upon the first end wall are disposed such that every or an overwhelming majority of the apertures within the first plurality of adjacent apertures is closer to the left wall 64 of the first tray than the right wall 62 of the first tray.

Representative Paragraph 15: The open food storage container of Representative Paragraph 14, wherein the second plurality of adjacent apertures upon the second end wall are disposed such that every or an overwhelming majority of the apertures within the second plurality of adjacent apertures is closer to the left wall of the first tray than the right wall of the first tray.

Representative Paragraph 16: The open food storage container of any one of Representative Paragraphs 3-15, wherein the surface of the second tray facing the receiving volume comprise a plurality of spaced stand-offs that extend outwardly from planar surfaces that are aligned to establish food resting surfaces of the second tray.

Representative Paragraph 17: The open food storage container of Representative Paragraph 16, wherein the second tray comprises a fifth plurality of apertures wherein air between the first and second trays blows through the plurality of fifth apertures and into the receiving volume.

Representative Paragraph 18: The open food storage container of Representative Paragraph 17, wherein the fifth plurality of apertures are spaced throughout a bottom and first and second end walls of the second tray, wherein the bottom is horizontal when disposed within the first tray and the housing, and the first and second end walls are each disposed at an obtuse angle with respect to the bottom.

Representative Paragraph 19: The open food storage container of any one of Representative Paragraphs 3-18, wherein when the second tray in installed within the open cavity of the first tray, a bottom of the second tray is disposed above all or a overwhelming majority of the first and second plurality of adjacent apertures.

Representative Paragraph 20: The open food storage container of any one of Representative Paragraphs 1-19, wherein the right and left side walls of the housing are substantially parallel with each other.

Representative Paragraph 21: An open food storage container, comprising:
a housing comprising a bottom, right and left side walls and first and second end portions that in combination establish a holding volume, wherein the side walls and end portions are arranged with the right side wall extending from the first and second end portions and the left side wall also extending from the first and second end portions, wherein the right and left side walls are substantially parallel with each other;
the first end portion includes a first air handling unit and a first heating element, wherein the first air handling unit is configured to draw air in a first direction through a suction substantially parallel to a plane parallel to the right and left side walls and discharge air in a second direction substantially perpendicular to the plane,
the second end portion includes a second air handling unit and a second heating element, wherein the second air handling unit is configured to draw air in a third direction through a suction, wherein the third direction is opposite from the first direction and substantially parallel to the plane, and discharge air in the second direction,
wherein the first air handling unit and the second air handling unit each include fans, wherein the fan in the first air handling unit rotates in a clockwise direction when viewed straight on from the holding volume, and the fan in the second air handling unit rotates in a counter-clockwise direction when viewed straight on from the holding volume,
further comprising a first tray that is received upon the housing and within the holding volume and the first tray is removable from the housing without the need for use of any tools, and a second tray that is received upon the first tray and within the holding volume, wherein the second tray is removable from the first tray without the need for use of any tools,
wherein the first tray comprises right and left side walls, first and second end walls, and a bottom wall, wherein the right and left side walls, the first and second end walls, and the bottom wall collectively establish an open cavity, wherein when the first tray is disposed within the housing the left wall of the first tray is proximate to the left side wall of the housing, the right wall of the first tray is proximate to the right side wall of the housing, the first end wall is proximate to the first end portion of the housing, and the second end wall is proximate to the second end portion of the housing.

Representative Paragraph 22: The open food storage container of Representative Paragraph 21, wherein the first tray comprises a first plurality of adjacent apertures that are disposed on the first end wall proximate to the first heating element at the first end portion when the first tray is disposed within the holding volume, a second plurality of adjacent apertures that are disposed on the second end wall proximate to the second heating element at the second end portion when the first tray is disposed within the holding volume.

Representative Paragraph 23: The open food storage container of either of Representative Paragraphs 21 or 22, wherein the first tray further comprises a third plurality of adjacent apertures that are disposed on the left wall, and a fourth plurality of adjacent apertures that are disposed on the right wall,
wherein a first gap is established between the left side wall of the housing and the left wall of the first tray, wherein a portion of the air that discharges from the first and second air handling units and flows past the adjacent respective first and second heating elements then flows into the first gap;
and wherein a second gap is established between the right side wall of the housing and the right wall of the first tray, wherein air flowing through the fourth plurality of adjacent apertures flows into the second gap, a first portion of the air flowing through the fourth plurality of apertures flows to the suction of the first air handling unit and a remaining portion of the air flowing through the fourth plurality of apertures flows to the suction of the second air handling unit.

Representative Paragraph 24: The open food storage container of Representative Paragraph 23, wherein air flows from the third plurality of adjacent apertures to the fourth plurality of adjacent apertures to establish an air curtain across the open cavity at an opening into the first tray.

Representative Paragraph 25: The open food storage container of Representative Paragraphs 23 or 24, wherein the second tray rests upon the first tray and establishes a third gap between adjacent walls of the second tray and the first tray.

Representative Paragraph 26: The open food storage container of Representative Paragraph 25, wherein air flowing through the first and second pluralities of adjacent apertures flows into the third gap, wherein the second tray comprises a fifth plurality of apertures disposed throughout the second tray, wherein air flowing into the third gap flows through the plurality of fifth apertures and into a receiving volume that is established by walls of the second tray.

Representative Paragraph 27: The open food storage container of Representative Paragraph 26, wherein when the second tray is disposed upon the first tray the receiving volume is nested within the open cavity of the first tray, and when the first tray is received within the housing the open cavity is disposed within the holding volume.

Representative Paragraph 28: The open food storage container of any of Representative Paragraphs 22-27, wherein first end wall of the first tray is planar, and the second end wall includes a first planar portion and second planar portion, wherein the first planar portion and the second planar portion intersect at a horizontal edge, wherein the first planar portion is disposed at a smaller angle with respect to the bottom wall than the second planar portion is disposed with respect to the bottom wall.

Representative Paragraph 29: The open food storage container of Representative Paragraph 28, wherein the first planar portion of the second end wall is about perpendicular to the bottom wall and the second planar portion of the first or second end wall is at an obtuse angle to the bottom wall.

Representative Paragraph 30: The open food storage container of Representative Paragraph 29, wherein the first end portion of the housing further comprises a first bulkhead disposed between the first air handling unit and the first heating element, wherein the first bulkhead includes an exposed edge that points into the holding volume, wherein the exposed edge establishes a straight line along its length,
wherein the second end portion of the housing further comprises a second bulkhead disposed between the second air handling unit and the second heating element, wherein the second bulkhead includes an exposed edge that points into the holding volume, wherein the exposed edge includes a first straight portion and a second straight portion that intersect each other, wherein the first straight portion is disposed at a smaller angle with respect to the bottom wall than the second straight portion is disposed with respect to the bottom wall.

Representative Paragraph 31: The open food storage container of Representative Paragraph 30, wherein the first and second bulkheads are configured such that the first tray can only positioned within the housing such that the first end of the first tray is adjacent the first end portion of the housing and the second end of the first tray is adjacent the second end portion of the housing.

Representative Paragraph 32: The open food storage container of any one of Representative Paragraphs 21-31, wherein the first plurality of adjacent apertures upon the first end wall are disposed such that every or an overwhelming majority of the apertures within the first plurality of adjacent apertures is closer to the left wall 64 of the first tray than the right wall 62 of the first tray.

Representative Paragraph 33: The open food storage container of Representative Paragraph 32, wherein the second plurality of adjacent apertures upon the second end wall are disposed such that every or an overwhelming majority of the apertures within the second plurality of adjacent apertures is closer to the left wall of the first tray than the right wall of the first tray.

Representative Paragraph 34: The open food storage container of any one of Representative Paragraphs 21-33, wherein the surface of the second tray facing the receiving volume comprise a plurality of spaced stand-offs that extend outwardly from planar surfaces that are aligned to establish food resting surfaces of the second tray.

Representative Paragraph 35: The open food storage container of Representative Paragraph 34, wherein the second tray comprises a fifth plurality of apertures wherein air between the first and second trays blows through the plurality of fifth apertures and into the receiving volume.

Representative Paragraph 36: The open food storage container of Representative Paragraph 35, wherein the fifth plurality of apertures are spaced throughout a bottom and first and second end walls of the second tray, wherein the bottom is horizontal when disposed within the first tray and the housing, and the first and second end walls are each disposed at an obtuse angle with respect to the bottom.

Representative Paragraph 37: The open food storage container of any one of Representative Paragraphs 21-36, wherein when the second tray in installed within the open cavity of the first tray, a bottom of the second tray is disposed above all or a overwhelming majority of the first and second plurality of adjacent apertures.

Representative Paragraph 38: The open food storage container of any one of Representative Paragraphs 21-38, wherein the right and left side walls of the housing are substantially parallel with each other.

Representative Paragraph 39: An open food storage container, comprising:
a housing comprising a food storage compartment and an air handling compartment, the housing formed from front, back, right, and left side walls, and a bottom wall, the air handling compartment includes a fan and a heater that is disposed proximate to a discharge of the fan such that air that flows through the discharge of the fan flows across the heater;
the food storage compartment is disposed proximate to the air handling compartment with a center wall that separates the food storage compartment from the air handling compartment, the center wall is parallel to the front wall of the housing,
the center wall includes a plurality of first holes disposed proximate to a top edge of the center wall, and a plurality of second holes disposed proximate to a bottom region of the food storage compartment;
further comprising a food storage tray that is removably received within the food storage compartment, wherein the food storage tray includes a bottom surface and right and left side walls that each extend upwardly from opposite ends of the bottom surface, the food storage tray include a plurality of spaced holes within the bottom surface,
wherein the food storage compartment comprises a width and a length, wherein the width is six inches.

Representative Paragraph 40: The open food storage container of Representative Paragraph 39, wherein the width extends between the center wall and a portion of the front wall that forms the food storage compartment.

Representative Paragraph 41: The open food storage container of Representative Paragraph 39 (or any one of Representative Paragraphs 39-40), wherein the bottom portion of the food storage tray includes a right portion, a left portion, and a center portion, wherein each of the right portion and the left portion extend away from the center portion, wherein the right portion and the left portion each include a planar portion, wherein the planar portion of each of the right portion and the left portion extend from the center portion at an acute angle with respect to a flat surface that the open food storage container rests upon.

Representative Paragraph 42: The open food storage container of Representative Paragraph 41, wherein the acute angle is within a range of about 8 degrees to about 15 degrees.

Representative Paragraph 43: The open food storage container of Representative Paragraph 42, wherein the plurality of second holes are arranged in a plurality of vertical columns that are proximate to each other, wherein the plurality of vertical columns are arranged such that from a center of center wall toward both right and left edges of the center wall the plurality of vertical columns are grouped into a first plurality with one second hole, then a second plurality with two stacked holes, then a third plurality with three stacked holes.

Representative Paragraph 44: The open food storage container of Representative Paragraph 43, further comprising after the third plurality with three stacked holes a fourth plurality with four stacked holes.

Representative Paragraph 45: The open food storage container of Representative Paragraph 43, wherein the first, second, and third plurality of vertical columns are arranged such a straight line extends from a hole within the first plurality and then through an upper most hole of the first stacked holes within the second plurality, and an upper most hole of the first stacked holes within the third plurality.

Representative Paragraph 46: The open food storage container of Representative Paragraph 45, wherein the straight line is substantially parallel with the planar portion of the right portion of the food storage tray when the food storage tray is properly positioned within the food storage compartment.

Representative Paragraph 47: The open food storage container of Representative Paragraph 45, wherein all of the holes within the plurality of second holes are vertically below the respective right planar portion or left planar portion of the food storage tray that is aligned vertically with the respective hole when the food storage tray is properly positioned within the food storage compartment.

Representative Paragraph 48: The open food storage container of Representative Paragraph 39 (or any one of Representative Paragraphs 39-47), wherein the fan within the air handling compartment is first and second fans, the first fan being disposed proximate to the right side wall of the housing and the second fan being disposed proximate to the left side wall of the housing, wherein the when the air handling compartment is viewed from the food handling compartment, the first fan rotates in a counter-clockwise direction, and the second fan rotates in a clockwise direction.

Representative Paragraph 49: The open food storage container of Representative Paragraph 48, wherein the heater comprises first and second heaters, wherein the first heater is disposed such that air that flows through the discharge of the first fan flows through the first heater and air that flows through the discharge of the second fan flow through the second heater.

Representative Paragraph 50: The open food storage container of Representative Paragraph 49, wherein the air that flows past each of the first and second heaters flows downwardly within the air handling compartment toward the plurality of second holes.

Representative Paragraph 51: The open food storage container of Representative Paragraph 39 (or any one of Representative Paragraphs 39-50), further comprising a panel disposed between the heater and the center wall that establishes an air flow plenum therebetween, wherein the panel prevents air from flowing from the heater and directly through the plurality of first holes.

Representative Paragraph 52: The open food storage container of Representative Paragraph 39 (or any one of Representative Paragraphs 39-51) wherein a length of the food storage compartment is about 20 inches.

Representative Paragraph 53: The open food storage container of Representative Paragraph 39 (or any one of Representative Paragraphs 39-52) wherein the width of housing is about 12 inches and the height of the housing is about 7 inches.

Representative Paragraph 54: An open food storage container, comprising:
a housing comprising a food storage compartment and an air handling compartment, the housing formed from front, back, right, and left side walls, and a bottom wall, the air handling compartment includes a fan and a heater that is disposed proximate to a discharge of the fan such that air that flows through the discharge of the fan flows across the heater;
the food storage compartment is disposed proximate to the air handling compartment with a center wall that separates the food storage compartment from the air handling compartment, the center wall is parallel to the front wall of the housing,
the center wall includes a plurality of first holes disposed proximate to a top edge of the center wall, and a plurality of second holes disposed proximate to a bottom region of the food storage compartment;
further comprising a food storage tray that is removably received within the food storage compartment, wherein the food storage tray includes a bottom surface and right and left side walls that each extend upwardly from opposite ends of the bottom surface, the food storage tray include a plurality of spaced holes within the bottom surface,
wherein the plurality of second holes are arranged in a plurality of vertical columns that are proximate to each other, wherein the plurality of vertical columns are arranged such that from a center of center wall toward both right and left edges of the center wall the plurality of vertical columns are grouped into a first plurality with one second hole, then a second plurality with two stacked holes, then a third plurality with three stacked holes.

Representative Paragraph 55: The open food storage container of Representative Paragraph 55, wherein the bottom portion of the food storage tray includes a right portion, a left portion, and a center portion, wherein each of the right portion and the left portion extend away from the center portion, wherein the right portion and the left portion each include a planar portion, wherein the planar portion of each of the right portion and the left portion extend from the center portion at an acute angle with respect to a flat surface that the open food storage container rests upon.

Representative Paragraph 56: The open food storage container of Representative Paragraph 55, wherein the acute angle is within a range of about 8 degrees to about 15 degrees.

Representative Paragraph 57: The open food storage container of Representative Paragraph 56, further comprising after the third plurality with three stacked holes a fourth plurality with four stacked holes.

Representative Paragraph 58: The open food storage container of Representative Paragraph 54 (or any one of Representative Paragraphs 55-57), wherein the first, second, and third plurality of vertical columns are arranged such a straight line extends from a hole within the first plurality and then through an upper most hole of the first stacked holes within the second plurality, and an upper most hole of the first stacked holes within the third plurality.

Representative Paragraph 59: The open food storage container of Representative Paragraph 58, wherein all of the holes within the plurality of second holes are vertically below the respective right planar portion or left planar portion of the food storage tray that is aligned vertically with the respective hole when the food storage tray is properly positioned within the food storage compartment.

Representative Paragraph 60: The open food storage container of Representative Paragraph 54 (or any one of Representative Paragraphs 54-59), further comprising after the third plurality with three stacked holes a fourth plurality with four stacked holes.

Representative Paragraph 61: The open food storage container of Representative Paragraph 54 (or any one of Representative Paragraphs 54-60), wherein the fan within the air handling compartment is first and second fans, the first fan being disposed proximate to the right side wall of the housing and the second fan being disposed proximate to the left side wall of the housing, wherein the when the air handling compartment is viewed from the food handling compartment, the first fan rotates in a counter-clockwise direction, and the second fan rotates in a clockwise direction.

Representative Paragraph 62: The open food storage container of Representative Paragraph 61, wherein the heater comprises first and second heaters, wherein the first heater is disposed such that air that flows through the discharge of the first fan flows through the first heater and air that flows through the discharge of the second fan flow through the second heater.

Representative Paragraph 63: The open food storage container of Representative Paragraph 62, wherein the air that flows past each of the first and second heaters flows downwardly within the air handling compartment toward the plurality of second holes.

Representative Paragraph 64: The open food storage container of Representative Paragraph 54 (or any one of Representative Paragraphs 54-63), further comprising a panel disposed between the heater and the center wall that establishes an air flow plenum therebetween, wherein the panel prevents air from flowing from the heater and directly through the plurality of first holes.

Representative Paragraph 65: The open food storage container of Representative Paragraph 54 (or any one of Representative Paragraphs 54-64) wherein a width of the food storage compartment is at or just above 6 inches, and the length of the food storage compartment is one or more of about 20, 24, 28, 32, or 26 inches.

Representative Paragraph 66: The open food storage container of Representative Paragraph 54 (or any one of Representative Paragraphs 54-65) wherein the width of housing is about 12 inches and the height of the housing is about 7 inches.

1. An open food storage container, comprising:
a housing comprising a bottom, right and left side walls, and first and second end portions that in combination establish a holding volume, wherein the side walls and end portions are arranged with the right side wall extending from the first and second end portions and the left side wall also extending from the first and second end portions;
the first end portion includes a first air handling unit and a first heating element, wherein the first air handling unit is configured to draw air in a first direction through a suction substantially parallel to a plane parallel to one or both of the right and left side walls and discharge air in a second direction substantially perpendicular to the plane,
the second end portion includes a second air handling unit and a second heating element, wherein the second air handling unit is configured to draw air in a third direction through a suction, wherein the third direction is opposite from the first direction and substantially parallel to the plane, and discharge air in the second direction.

2. The open food storage container of claim 1, wherein the first air handling unit and the second air handling unit each include fans, wherein the fan in the first air handling unit rotates in a clockwise direction when viewed straight on from the holding volume, and the fan in the second air handling unit rotates in a counter-clockwise direction when viewed straight on from the holding volume.

3. The open food storage container of claim 1, further comprising a first tray that is received upon the housing and within the holding volume and the first tray is removable from the housing without the need for use of any tools, and a second tray that is received upon the first tray and within the holding volume, wherein the second tray is removable from the first tray without the need for use of any tools,
wherein the first tray comprises right and left side walls, first and second end walls, and a bottom wall, wherein the right and left side walls, the first and second end walls, and the bottom wall collectively establish an open cavity, wherein when the first tray is disposed within the housing the left wall of the first tray is proximate to the left side wall of the housing, the right wall of the first tray is proximate to the right side wall of the housing, the first end wall is proximate to the first end portion of the housing, and the second end wall is proximate to the second end portion of the housing.

4. The open food storage container of claim 3, wherein the first tray comprises a first plurality of adjacent apertures that are disposed on the first end wall proximate to the first heating element at the first end portion when the first tray is disposed within the holding volume, a second plurality of adjacent apertures that are disposed on the second end wall proximate to the second heating element at the second end portion when the first tray is disposed within the holding volume.

5. The open food storage container of claim 4, wherein the first tray further comprises a third plurality of adjacent apertures that are disposed on the left wall, and a fourth plurality of adjacent apertures that are disposed on the right wall,
wherein a first gap is established between the left side wall of the housing and the left wall of the first tray, wherein a portion of the air that discharges from the first and second air handling units and flows past the adjacent respective first and second heating elements then flows into the first gap;
and wherein a second gap is established between the right side wall of the housing and the right wall of the first tray, wherein air flowing through the fourth plurality of adjacent apertures flows into the second gap, a first portion of the air flowing through the fourth plurality of apertures flows to the suction of the first air handling unit and a remaining portion of the air flowing through the fourth plurality of apertures flows to the suction of the second air handling unit.

6. The open food storage container of claim 5, wherein air flows from the third plurality of adjacent apertures to the fourth plurality of adjacent apertures to establish an air curtain across the open cavity at an opening into the first tray.

7. The open food storage container of claim 5, wherein the second tray rests upon the first tray and establishes a third gap between adjacent walls of the second tray and the first tray.

8. The open food storage container of claim 7, wherein air flowing through the first and second pluralities of adjacent apertures flows into the third gap, wherein the second tray comprises a fifth plurality of apertures disposed throughout the second tray, wherein air flowing into the third gap flows through the plurality of fifth apertures and into a receiving volume that is established by walls of the second tray.

9. The open food storage container of claim 8, wherein when the second tray is disposed upon the first tray the receiving volume is nested within the open cavity of the first tray, and when the first tray is received within the housing the open cavity is disposed within the holding volume.

10. The open food storage container of claim 3, wherein first end wall of the first tray is planar, and the second end wall includes a first planar portion and second planar portion, wherein the first planar portion and the second planar portion intersect at a horizontal edge, wherein the first planar portion is disposed at a smaller angle with respect to the bottom wall than the second planar portion is disposed with respect to the bottom wall.

11. The open food storage container of claim 10, wherein the first planar portion of the second end wall is about perpendicular to the bottom wall and the second planar portion of the first or second end wall is at an obtuse angle to the bottom wall.

12. The open food storage container of claim 10, wherein the first end portion of the housing further comprises a first bulkhead disposed between the first air handling unit and the first heating element, wherein the first bulkhead includes an exposed edge that points into the holding volume, wherein the exposed edge establishes a straight line along its length,
wherein the second end portion of the housing further comprises a second bulkhead disposed between the second air handling unit and the second heating element, wherein the second bulkhead includes an exposed edge that points into the holding volume, wherein the exposed edge includes a first straight portion and a second straight portion that intersect each other, wherein the first straight portion is disposed at a smaller angle with respect to the bottom wall than the second straight portion is disposed with respect to the bottom wall.

13. The open food storage container of claim 12, wherein the first and second bulkheads are configured such that the first tray can only positioned within the housing such that the first end of the first tray is adjacent the first end portion of the housing and the second end of the first tray is adjacent the second end portion of the housing.

14. The open food storage container of claim 4, wherein the first plurality of adjacent apertures upon the first end wall are disposed such that every or an overwhelming majority of the apertures within the first plurality of adjacent apertures is closer to the left wall of the first tray than the right wall of the first tray.

15. The open food storage container of claim 14, wherein the second plurality of adjacent apertures upon the second end wall are disposed such that every or an overwhelming majority of the apertures within the second plurality of adjacent apertures is closer to the left wall of the first tray than the right wall of the first tray.

16. The open food storage container of claim 4, wherein the surface of the second tray facing the receiving volume comprise a plurality of spaced stand-offs that extend outwardly from planar surfaces that are aligned to establish food resting surfaces of the second tray.

17. The open food storage container of claim 16, wherein the second tray comprises a fifth plurality of apertures wherein air between the first and second trays blows through the plurality of fifth apertures and into the receiving volume.

18. The open food storage container of claim 17, wherein the fifth plurality of apertures are spaced throughout a bottom and first and second end walls of the second tray, wherein the bottom is horizontal when disposed within the first tray and the housing, and the first and second end walls are each disposed at an obtuse angle with respect to the bottom.

19. The open food storage container of claim 4, wherein when the second tray in installed within the open cavity of the first tray, a bottom of the second tray is disposed above all or a overwhelming majority of the first and second plurality of adjacent apertures.

20. The open food storage container of claim 1, wherein the right and left side walls of the housing are substantially parallel with each other.

21. An open food storage container, comprising:
a housing comprising a bottom, right and left side walls and first and second end portions that in combination establish a holding volume, wherein the side walls and end portions are arranged with the right side wall extending from the first and second end portions and the left side wall also extending from the first and second end portions, wherein the right and left side walls are substantially parallel with each other;
the first end portion includes a first air handling unit and a first heating element, wherein the first air handling unit is configured to draw air in a first direction through a suction substantially parallel to a plane parallel to the right and left side walls and discharge air in a second direction substantially perpendicular to the plane,
the second end portion includes a second air handling unit and a second heating element, wherein the second air handling unit is configured to draw air in a third direction through a suction, wherein the third direction is opposite from the first direction and substantially parallel to the plane, and discharge air in the second direction,
wherein the first air handling unit and the second air handling unit each include fans, wherein the fan in the first air handling unit rotates in a clockwise direction when viewed straight on from the holding volume, and the fan in the second air handling unit rotates in a counter-clockwise direction when viewed straight on from the holding volume,
further comprising a first tray that is received upon the housing and within the holding volume and the first tray is removable from the housing without the need for use of any tools, and a second tray that is received upon the first tray and within the holding volume, wherein the second tray is removable from the first tray without the need for use of any tools,
wherein the first tray comprises right and left side walls, first and second end walls, and a bottom wall, wherein the right and left side walls, the first and second end walls, and the bottom wall collectively establish an open cavity, wherein when the first tray is disposed within the housing the left wall of the first tray is proximate to the left side wall of the housing, the right wall of the first tray is proximate to the right side wall of the housing, the first end wall is proximate to the first end portion of the housing, and the second end wall is proximate to the second end portion of the housing.
